(19) United States
(12) Patent Application Publication
(10) Pub. No.: US 2025/0024296 A1
(43) Pub. Date: Jan. 16, 2025

(54) ADVANCED UE BEAM REPORTING

(71) Applicant: Samsung Electronics Co., Ltd., Suwon-si (KR)

(72) Inventors: Emad Nader Farag, Flanders, NJ (US); Eko Onggosanusi, Coppell, TX (US); Md. Saifur Rahman, Plano, TX (US); Dalin Zhu, Allen, TX (US)

(21) Appl. No.: 18/762,562

(22) Filed: Jul. 2, 2024

Related U.S. Application Data
(60) Provisional application No. 63/526,853, filed on Jul. 14, 2023.
(60) Provisional application No. 63/537,387, filed on Sep. 8, 2023.
(60) Provisional application No. 63/602,217, filed on Nov. 22, 2023.

(51) Int. Cl. H04W 24/10

(52) U.S. Cl. CPC H04W 24/10

(57) ABSTRACT

Methods and apparatuses for advanced user equipment (UE) beam reporting in a wireless communication system. A method of operating a UE includes receiving a set of reference signals (RSs), measuring a first quantity based on a quality of a RS in the set of RSs, determining a second quantity based on a rate of change of the first quantity, preparing a report including N≥1 entries, and transmitting the report. Each entry in the N entries includes a RS indicator of the RS, the first quantity, and the second quantity;

### CROSS-REFERENCE TO RELATED APPLICATIONS AND CLAIM OF PRIORITY

The present application claims priority to:
U.S. Provisional Patent Application No. 63/526,853, filed on Jul. 14, 2023;
U.S. Provisional Patent Application No. 63/537,387, filed on Sep. 8, 2023; and
U.S. Provisional Patent Application No. 63/602,217, filed on Nov. 22, 2023. The contents of the above-identified patent documents are incorporated herein by reference.

### TECHNICAL FIELD

The present disclosure relates generally to wireless communication systems and, more specifically, the present disclosure relates to an advanced user equipment (UE) beam reporting in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to an advanced UE beam reporting in a wireless communication system.

In one embodiment, a user equipment (UE) is provided. The UE includes a transceiver configured to receive a set of reference signals (RSs) and a processor operably coupled to the transceiver. The processor is configured to measure a first quantity based on a quality of a RS in the set of RSs, determine a second quantity based on a rate of change of the first quantity, and prepare a report including N≥1 entries. Each entry in the N entries includes a RS indicator of the RS, the first quantity, and the second quantity. The transceiver is further configured to transmit the report.

In another embodiment, a base station (BS) is provided. The BS includes a processor and a transceiver operably coupled to the processor. The transceiver is configured to transmit a set of RSs and receive a report, wherein the report includes N≥1 entries. Each entry in the N entries includes a RS indicator of a RS in the set of RSs, a first quantity that is based on a quality of the RS, and a second quantity that is based on a rate of change of the first quantity.

In yet another embodiment, a method of operating a UE is provided. The method includes receiving a set of RSs, measuring a first quantity based on a quality of a RS in the set of RSs, determining a second quantity based on a rate of change of the first quantity, preparing a report including N≥1 entries, and transmitting the report. Each entry in the N entries includes a RS indicator of the RS, the first quantity, and the second quantity.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate examples of wireless transmit and receive paths according to the present disclosure;

FIG. 6A illustrates an example of wireless system beam according to embodiments of the present disclosure;

FIG. 6B illustrates an example of multi-beam operation according to embodiments of the present disclosure;

FIG. 7 illustrates an example of antenna structure according to embodiments of the present disclosure;

FIG. 8 illustrates an example of reactive procedure according to embodiments of the present disclosure;

FIG. 9 illustrates an example of UE measurement according to embodiments of the present disclosure;

FIG. 10 illustrates an example of transmission power according to embodiments of the present disclosure;

FIG. 11 illustrates an example of TRPs according to embodiments of the present disclosure;

FIG. 12 illustrates an example of network architecture for TRPs according to embodiments of the present disclosure;

FIG. 13 illustrates an example of UE configuration according to embodiments of the present disclosure;

FIG. 14 illustrates an example of spatial domain transmission according to embodiments of the present disclosure;

FIG. 15 illustrates an example of signaling flow for RACH operation according to embodiments of the present disclosure;

FIG. 16 illustrates an example of network architecture for RACH operation according to embodiments of the present disclosure; and

FIG. 17 illustrates an example of SRS resources according to embodiments of the present disclosure.

### DETAILED DESCRIPTION

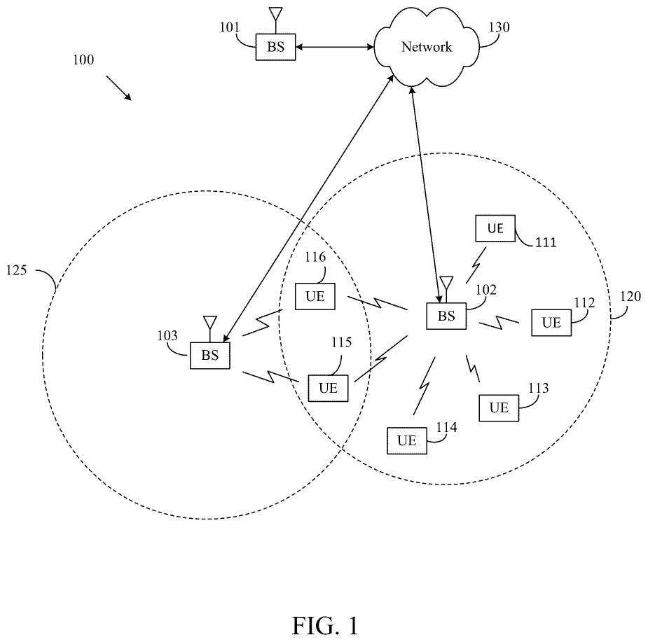

FIG. 1 through FIG. 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v17.7.0, “NR; Physical channels and modulation”; 3GPP TS 38.212 v17.7.0, “NR; Multiplexing and Channel coding”; 3GPP TS 38.213 v17.7.0, “NR; Physical Layer Procedures for Control”; 3GPP TS 38.214 v17.7.0, “NR; Physical Layer Procedures for Data”; 3GPP TS 38.321 v17.6.0, “NR; Medium Access Control (MAC) protocol specification”; 3GPP TS 38.331 v17.6.0, “NR; Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for advanced UE beam reporting in a wireless communication system. In certain embodiments, and one or more of the gNBs 101-103 includes circuitry, programing, or a combination thereof, for supporting advanced UE beam reporting in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

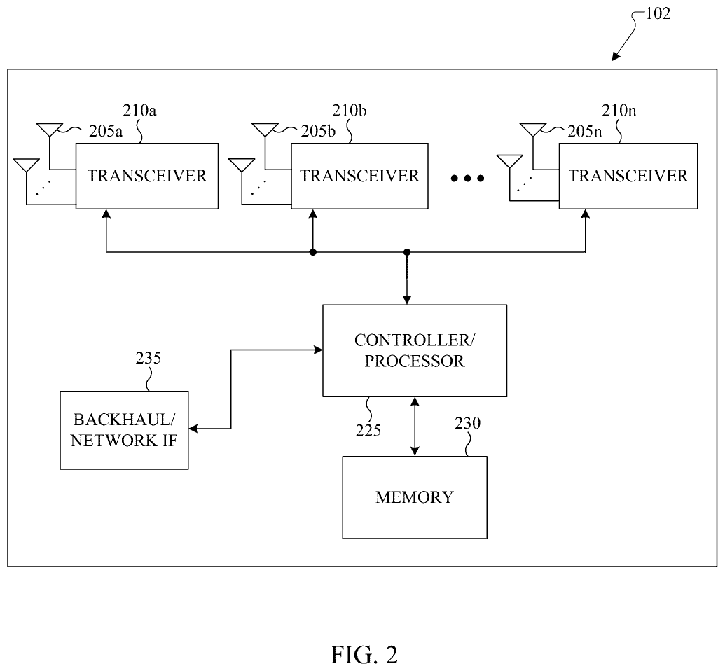

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing g circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels or signals and the transmission of DL channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting an advanced UE beam reporting in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

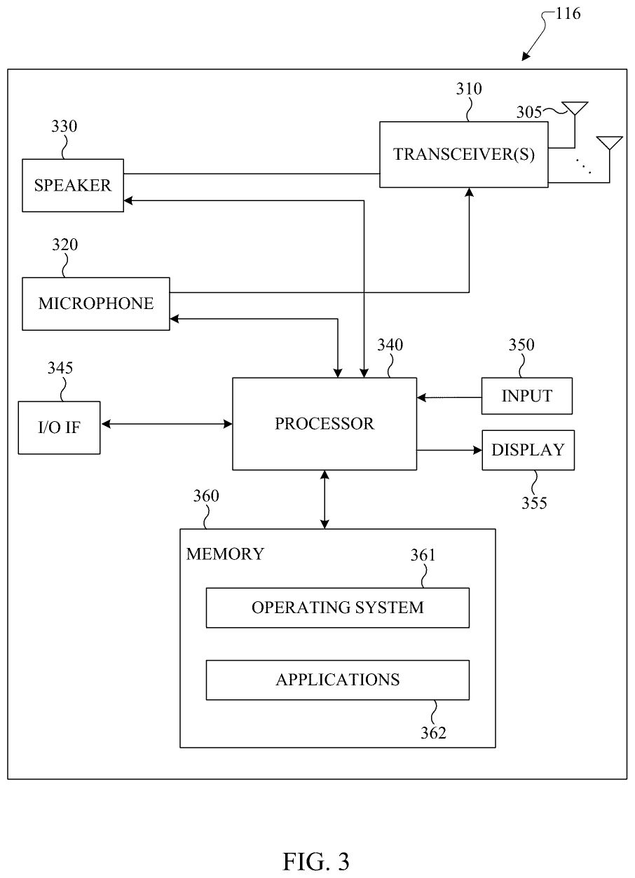

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals, the transmission of UL channels or signals, and reception and transmission of SL channels or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for an advanced UE beam reporting in a wireless communication system.

The processor 340 can move data into or out of the memory 360 as required by an executing process. In some embodiments, the processor 340 is configured to execute the applications 362 based on the OS 361 or in response to signals received from gNBs, another UE, or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

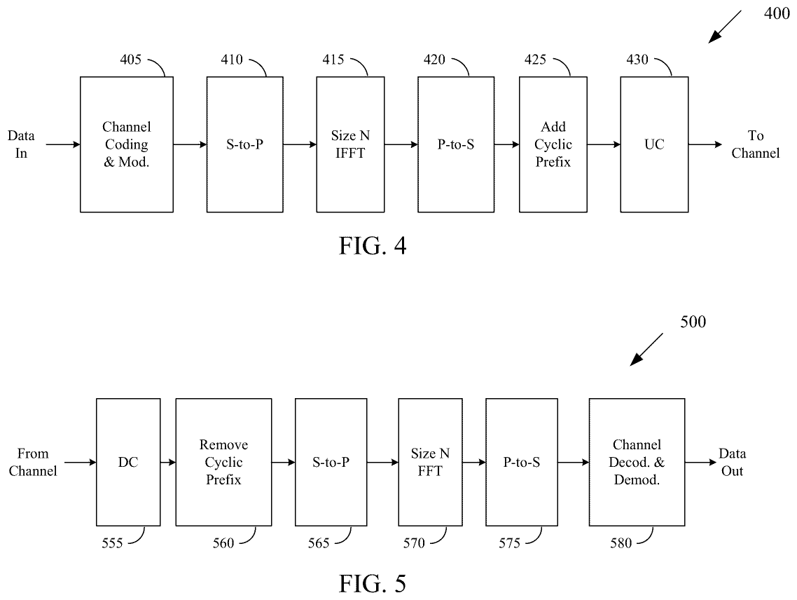

FIG. 4 and FIG. 5 illustrate example wireless transmit and receive paths according to this disclosure. The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 or another UE arrives at the UE 116 after passing through the wireless channel, and reverse operations to those at the gNB 102 or another UE are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 or transmitting in the sidelink to another UE and may implement the receive path 500 for receiving in the downlink from the gNBs 101-103 or receiving in the sidelink from another UE. In some embodiments, the transmit path 400 and/or receive path 500 is configured to support advanced UE beam reporting in a wireless communication system as described in embodiments of the present disclosure.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of the present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A communication system can include a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency or bandwidth (BW) unit is referred to as a resource block (RB). One RB includes a number of sub-carriers (SCs). For example, a slot can have duration of one millisecond or 0.5 millisecond and an RB can have a bandwidth of 180 kHz or 720 kHz and include 12 SCs with inter-SC spacing of 15 kHz or 30 kHz respectively. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with CRC scrambled by C-RNTI/CS-RNTI/MCS-C-RNTI as described in 3GPP specification, are referred for brevity as a unicast DCI format. A DCI format scheduling PDSCH reception for multicast communication, such as a DCI format with CRC scrambled by G-RNTI/G-CS-RNTI as described in 3GPP specification, are referred to as multicast DCI format. DCI formats providing various control information to at least a subset of UEs in a serving cell, such as DCI format 2_0 in 3GPP specification, are referred to as group-common (GC) DCI formats.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources.

A UE can determine CSI-RS transmission parameters through DL control signaling or higher layer signaling, such as radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in its buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random access channel (PRACH).

In this disclosure, a time-unit can be a symbol, a number or group of symbols, a slot, a number or group of slots, a sub-frame, a number or group of sub-frames, a frame, or a number or group of frames.

In this disclosure, a beam is determined by either of: (1) a TCI state, that establishes a quasi-colocation (QCL) relationship or spatial relation between a source reference signal (e.g., a synchronization signal block (SS/PBCH block or SSB) and/or channel state information reference signal (CSI-RS)) and a target reference signal; or (2) a spatial relation information that establishes an association to a source reference signal, such as SSB or CSI-RS or SRS.

In either case, the ID of the source reference signal or TCI state or spatial relation identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

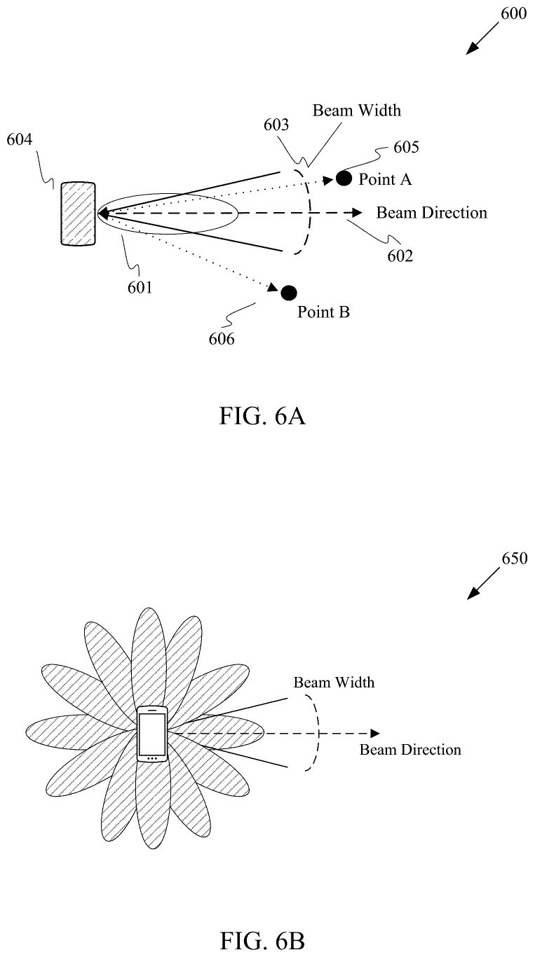

FIG. 6A illustrates an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrates an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi-co-location relationship is configured by the higher layer parameter qel-Type1 for the first DL RS, and qcl-Type2 for the second DL RS (if configured). For the case of two DL RSs, the QCL types may not be the same, regardless of whether the references are to the same DL RS or different DL RSs. The quasi-co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot (n+3Nₛₗₒₜ^{subframe,μ}).

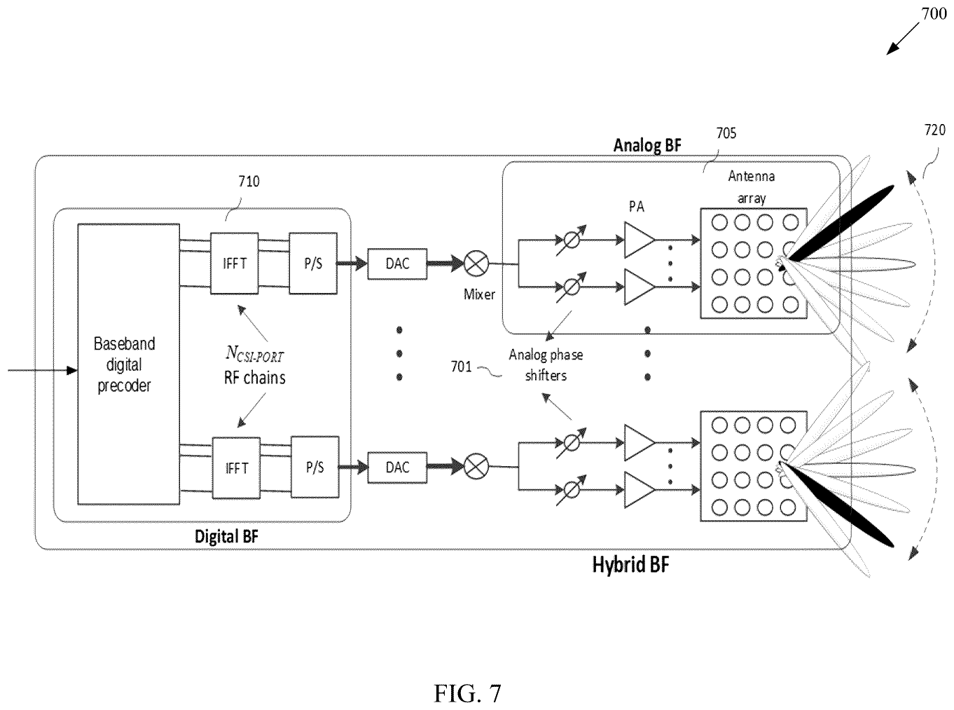

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 7.

FIG. 7 illustrates an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration-to be performed from time to time), the term “multi-beam operation” is used to refer to the overall system aspect. This includes, for the purpose of illustration, indicating the assigned DL or UL or SL TX beam (also termed “beam indication”), measuring at least one reference signal for calculating and performing beam reporting (also termed “beam measurement” and “beam reporting,” respectively), and receiving a DL or UL or SL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100m distance), larger number of and sharper analog beams (hence larger number of radiators in the array) may be needed to compensate for the additional path loss.

Rel-17 introduced the unified TCI framework, where a unified or master or main or indicated TCI state is signaled or indicated to the UE. The unified or master or main or indicated TCI state can be one of: (1) in case of joint TCI state indication, wherein a same beam is used for DL and UL channels, a joint TCI state that can be used at least for UE-dedicated DL channels and UE-dedicated UL channels; (2) in case of separate TCI state indication, wherein different beams are used for DL and UL channels, a DL TCI state that can be used at least for UE-dedicated DL channels; and/or (3) in case of separate TCI state indication, wherein different beams are used for DL and UL channels, a UL TCI state that can be used at least for UE-dedicated UL channels.

Quasi-co-location (QCL) relation, can be quasi-location with respect to one or more of the following relations: (1) Type A, {Doppler shift, Doppler spread, average delay, delay spread}; (2) Type B, {Doppler shift, Doppler spread}; (3) Type C, {Doppler shift, average delay}; and (4) Type D, {Spatial Rx parameter}.

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state is a DL or a joint TCI state of UE-dedicated reception on PDSCH/PDCCH and the CSI-RS applying the indicated TCI state and/or an UL or a Joint TCI state for dynamic-grant/configured-grant based PUSCH, PUCCH and SRS applying the indicated TCI state. The unified (master or main or indicated) TCI state applies at least to UE dedicated DL and UL channels. The unified (master or main or indicated) TCI can also apply to other DL and/or UL channels and/or signals e.g., non-UE dedicated channel and SRS.

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI Format can be with a DL assignment or without a DL assignment. A TCI state (TCI state code point) indicated in a DL related DCI format is applied after a beam application time from the corresponding HARQ-ACK feedback. The TCI state codepoint can be one of (1) a DL TCI state; (2) an UL TCI state; (3) a joint TCI state; or (4) a pair of DL TCI state and UL TCI state. DL TCI states, UL TCI states and a pair of DL/UL TCI states are used when the UE is configured with separate beam indication (separate TCI states for DL and UL). Joint TCI states are used when the UE is configured with Joint beam indication (Joint TCI state for DL and UL).

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

In this disclosure, a predictive beam reporting is provided wherein a UE provides a beam measurement report and the beam measurement report includes an indication of change of future beam measurements or a future beam measurement.

In 3GPP, the beam management procedure involves configuring a reference signal for beam measurement, the UE receives and measures the reference signals configured for beam measurement, and provides a beam measurement report based on the measurement. The network uses the beam measurement report to determine the beams to use when communicating with the UE. The network determines the TCI state or states and indicates the TCI state or states to the UE.

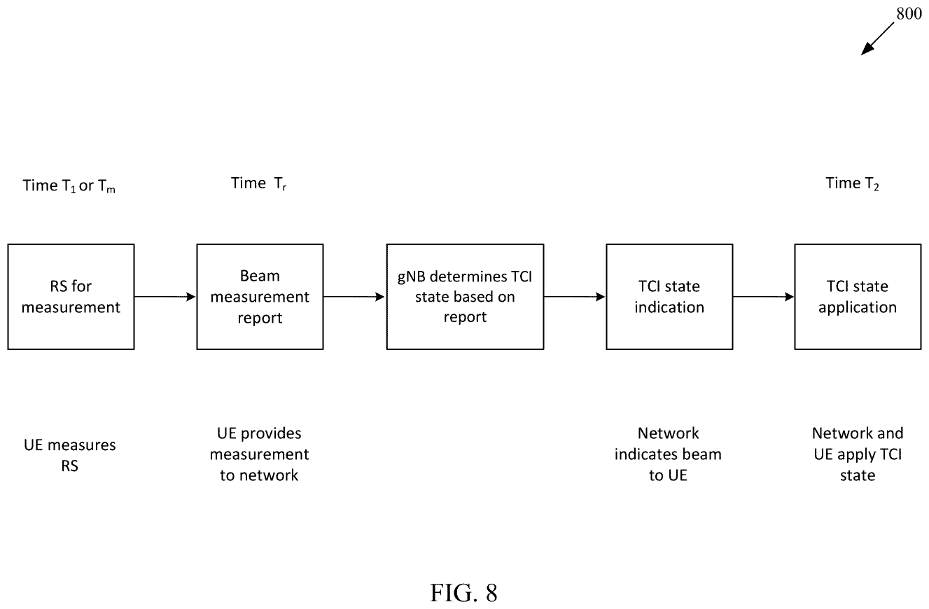

FIG. 8 illustrates an example of reactive procedure 800 according to embodiments of the present disclosure. An embodiment of the reactive procedure 800 shown in FIG. 8 is for illustration only.

As illustrated in FIG. 8, in a first step, the gNB (network) transmits a reference signal for measurement (e.g., beam measurement). For example, the reference signal can be SSB and/or non-zero power (NZP) CSI-RS. The UE receives and measures the RS used for measurement. This is performed a time T₁.

In a second step, the UE prepares a measurement report (e.g., beam measurement) for example, this can be a CSI report, and transmits the measurement report to the gNB (or network). The measurement report can be included in a physical uplink control channel (PUCCH), or a physical uplink shared channel (PUSCH). The gNB receives and decodes the corresponding uplink channels and the determines the measurement report.

In a third step, based on the measurement report, the gNB (or network) determines the beam(s) (or TCI state(s) or spatial relation(s)) to use for DL and/or UL communication with the UE. The measurements used in this determination have been performed sometime in the past (e.g., at time T₁).

In a fourth step, the gNB (or network) signals the determined beam(s) or TCI state(s) or spatial relation(s) to the UE. For example, this can be performed by a DCI format with or without a DL assignment that includes a “transmission configuration indicator,” which can correspond a to a code point activated by a MAC CE. The fourth step can also include MAC CE TCI state codepoint activation.

In a fifth step, the UE and the gNB (or network) apply and use the indicated beam(s) or TCI state(s) or spatial relation(s). For example, this can be a beam application time after the last symbol of a channel conveying a HARQ-ACK (e.g., positive HARQ-ACK) for the channel conveying the TCI state(s). As indicated in FIG. 6, the beams are activated at time T₂. The activated beam(s) are based on measurements that have been performed sometime in the past (e.g., at time T₁).

As described above, the measurement used to determine the beams for communicating with a UE, is a measurement in the past for beams to be used in the future. In a fast changing environment, the beams determined can be obsolete at the time of beam determination or at the time beam application and usage. To overcome this, the UE can provide beam measurement predictive quantities that can be used to assist in determining a future beam.

In this disclosure, predictive beam measurement operations are provided: (1) a measurement report can include an indication of whether a measurement quantity is improving or getting worse overtime or a rate of change of a measurement quantity; (2) a measurement report can include a measurement at a future time; and (3) a measurement report can include a time metric corresponding to a resource indicator.

The present disclosure relates to a 5G/NR communication system. The present disclosure provides aspects to predictive beam reporting from the UE. The following aspects are provided: (1) a measurement report can include an indication of whether a measurement quantity is improving or getting worse overtime or a rate of change of a measurement quantity; (2) a measurement report can include a measurement at a future time; and (3) a measurement report can include a time metric corresponding to a resource indicator.

In the following, both FDD and TDD are considered as a duplex method for DL and UL signaling. Although exemplary descriptions and embodiments to follow assume OFDM or OFDMA, the present disclosure can be extended to other OFDM-based transmission waveforms or multiple access schemes such as filtered OFDM (F-OFDM).

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI).

As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE.

A CSI report (e.g., for beam measurement) can be configured to have the following time domain behavior: (1) a periodic CSI report with a configured periodicity and offset; (2) a semi-persistent CSI report, wherein the report can be activated or deactivated. In one example, the activation or deactivation can be by MAC CE signaling. In another example, the activation or deactivation can be by L1 control (e.g., DCI) signaling; (3) an aperiodic CSI report, wherein the report can be triggered. In one example, the triggering can be by L1 control (e.g., DCI) signaling. In one example, the triggering can be by MAC CE signaling; and (4) in one example, the CSI report can be initiated or triggered by the UE.

In one example, a CSI report (e.g., for beam measurement) can be transmitted on PUCCH. In one example, a CSI report (e.g., for beam measurement) can be transmitted on PUSCH. In one example, a CSI report (e.g., for beam measurement) can be configured to be transmitted on PUCCH, and if the would-be PUCCH transmission overlaps with a PUSCH transmission, the CSI report (e.g., for beam measurement) is multiplexed on the PUSCH transmission.

The measurement RS used for CSI reporting can be configured to have the following time domain behavior: (1) a periodic RS (e.g., periodic CSI-RS), with a configured periodicity and offset; (2) a semi-persistent RS (e.g., semi-persistent CSI-RS), wherein the RS can be activated or deactivated. In one example, the activation or deactivation can be by MAC CE signaling. In another example, the activation or deactivation can be by L1 control (e.g., DCI) signaling; (3) an aperiodic RS (e.g., aperiodic CSI-RS), wherein the RS can be triggered. In one example, the triggering can be by L1 control (e.g., DCI) signaling. In one example, the triggering can be by MAC CE signaling; and (4) in one example, the RS (e.g., CSI-RS) can be initiated or triggered by the UE, for example the UE sends signal to the gNB to trigger the transmission of the RS.

In one example, a CSI report (e.g., for beam measurement) includes N CSI report groups, wherein each CSI report group includes at least: (1) a resource indicator. For example, this can be CSI-RS resource indicator (CRI) or SSB resource indicator (SSBRI); and (2) a quality metric associated with the resource indicator. In one example, the quality metric can be reference signal received power (RSRP), e.g., L1 RSRP. In one example the quality metric can be signal-to-noise ratio (SINR). In one example, the quality metric can be L3 RSRP (for example this be L1 RSRP that is long-term averaged, e.g., exponentially averaged or using a sliding window). In one example, the first quality metric is an absolute value. In one example, the first quality metric of the N quality metrics has the largest value. In one example, the remaining N−1 quality metrics (e.g., excluding the first quality metric), are relative to the first quality metric. In one example, all N quality metrics are in absolute value. In one example, the quality metric can be a P-MPR value (for MPE reporting). In one example, the quality metric is a pair (A, B), where A is at least one of RSRP and SINR, and B is a P-MPR value. In one example, the quality metric is A or B based on higher layer configuration.

In one example, N is specified in the system specification, e.g., N=4. In one example N is configured/updated by higher layer signaling, e.g., RRC signaling. In one example, N can be configured and/or updated by MAC CE signaling and/or L1 control signaling, e.g., DCI signaling. In one example, a default value for N is used (e.g., specified in the system specification) if N is not configured/updated by RRC signaling and/or MAC CE signaling and/or L1 control signaling. TABLE 1 shows an example of a measurement report with N CSI report groups.

TABLE 1
Measurement report

| CSI Report Group Number | Resource Indicator | Quality Metric |
|---|---|---|
| CSI Report group #1 | Resource Indicator#1 | Quality Metric#1 |
| CSI Report group #2 | Resource Indicator#2 | Quality Metric#2 |
| . . . | . . . | . . . |
| CSI Report group #N | Resource Indicator#N | Quality Metric#N |

In a further example, associated with each CSI report group is a quality indicator. In one example, the quality indicator can be explicitly indicated. This is shown in TABLE 2.

TABLE 2
Measurement report

| CSI Report Group Number | Resource Indicator | Quality Metric | Quality Indicator |
|---|---|---|---|
| CSI Report group #1 | Resource Indicator#1 | Quality Metric#1 | Quality Indicator#1 |
| CSI Report group #2 | Resource Indicator#2 | Quality Metric#2 | Quality Indicator#2 |
| . . . | . . . | . . . | . . . |
| CSI Report group #N | Resource Indicator#N | Quality Metric#N | Quality Indicator#N |

In one example, the terms “increasing,” “same,” and “decreasing,” refer to or are analogous to positive (>0), zero (=0), and negative (<0), respectively, or positive, zero, and negative values, respectively.

In one example the quality indicator #n (in) for CSI Report group #n is a 1-bit flag. In one sub-example, if quality metric #n is increasing or (is remaining the same or increasing), iₙ=1, else quantity #n is (remaining the same or decreasing) or is decreasing iₙ=0. In one sub-example, in example, if quality metric #n is decreasing or (is remaining the same or decreasing), iₙ=1, else quantity #n is (remaining the same or increasing) or is increasing iₙ=0.

In one example, the quality indicator #n (iₙ) for CSI Report group #n is a flag that can indicate whether the corresponding resource indicator #n is preferred or not preferred by the UE. In one sub-example, if iₙ=0, resource indicator #n is non-preferred, and if iₙ=1, resource indicator #n is preferred. In one sub-example, if iₙ=0, resource indicator #n is preferred, and if iₙ=1, resource indicator #n is non-preferred.

In one example, the term “undetermined” refers to or is analogous to a value, or NaN.

In one example, the quality indicator #n (iₙ) for CSI Report group #n can indicate whether quality metric #n is neither increasing or decreasing. For example, iₙ ∈ {increasing, same, decreasing} or {>0,0, <0} or {−1,0,1}}.

In one example, the quality indicator #n (iₙ) for CSI Report group #n can indicate that the change in quality metric #n is undetermined: (1) in one example, iₙ∈ {increasing, decreasing, undetermined}, or (2) in one example, iₙ ∈ {increasing, same, decreasing, undetermined}.

In one example, the term “increasing at fast rate” refers to or is analogous to fast acceleration (a₁), the term “increasing at slower rate” refers to or is analogous to slow acceleration (a₂), the term “decreasing at fast rate” refers to or is analogous to fast deceleration (d₁), the term “decreasing at slower rate” refers to or is analogous to slow deceleration (d₂). In one example, d₁<d₂<0<a₂<a₁.

In one example, the quality indicator can provide an indication of the rate of change (or acceleration/deceleration) of the corresponding quality metric. In one example, “increasing” can be “increasing at fast rate” or “increasing at a slow rate.” Similarly, “decreasing” can be “decreasing at fast rate” or “decreasing at a slow rate.” The following examples of in can be envisioned:

$${i}_{n} ∈ \{ increasing at fast rate , increasing at slow rate , decreasing at fast rate , decreasing at slow rate \} ; \qquad ( 1 )$$

$${i}_{n} ∈ \{ increasing at fast rate , increasing at slow rate , same , decreasing at fast rate , decreasing at slow rate \} ; \qquad ( 2 )$$

$${i}_{n} ∈ \{ increasing at fast rate , increasing at slow rate , decreasing at fast rate , decreasing at slow rate , undetermined \} ; and \qquad ( 3 )$$

$${i}_{n} ∈ \{ increasing at fast rate , increasing at slow rate , same , decreasing at fast rate , decreasing at slow rate , undetermined \} . \qquad ( 4 )$$

In one example, “increasing” can be “increasing at fast rate” or “increasing at a moderate rate” or “increasing at a slow rate.” Similarly, “decreasing” can be “decreasing at fast rate” or “decreasing at moderate rate” or “decreasing at a slow rate.” The following examples of iₙ can be envisioned:

$${i}_{n} ∈ \{ increasing at fast rate , increasing at moderate rate , increasing at slow rate , decreasing at fast rate , decreasing at moderate rate , decreasing at slow rate \} ; \qquad ( 1 )$$

$${i}_{n} ∈ \{ increasing at fast rate , increasing at moderate rate , increasing at slow rate , same , decreasing at fast rate , decreasing at moderate rate , decreasing at slow rate \} ; \qquad ( 2 )$$

$${i}_{n} ∈ \{ increasing at fast rate , increasing at moderate rate , increasing at slow rate , decreasing at fast rate , decreasing at moderate rate , decreasing at slow rate , undetermined \} ; and \qquad ( 3 )$$

$${i}_{n} ∈ \{ increasing at fast rate , increasing at moderate rate , increasing at slow rate , same , decreasing at fast rate , decreasing at moderate rate , decreasing at slow rate , undetermined \} . \qquad ( 4 )$$

In another example, there could be more levels for the rate of increase or decrease (e.g., L levels, d₁< ⋅ ⋅ ⋅ <d₁<0<a_{L}< ⋅ ⋅ ⋅ <a₁, where L can be fixed, (e.g., 2), or configured).

In one example, a single quality indicator i is provided in the measurement report.

In one example, i applies to all quality metrics in the measurement report.

In one example, i applies to the first quality metric (e.g., for CSI Report group #1) in the measurement report.

In one example, i applies to the first M quality metrics in the measurement report. In one example, M is specified in the system specification. In one example M is configured/updated by higher layer signaling, e.g., RRC signaling. In one example, M can be configured and/or updated by MAC CE signaling and/or L1 control signaling e.g., DCI signaling. In one example, a default value for M is used (e.g., specified in the system specification) if M is not configured/updated by RRC signaling and/or MAC CE signaling and/or L1 control signaling. In one example, M is reported by the UE in the measurement report. In one example, M is reported by the UE in a message separate from the measurement report.

In one example, in (or i) is valid (e.g., in (or i) is applicable) over a time period, T or time periods time periods Tₐ and T_{b}.

In one example, let Tₘ be the time of measurement (e.g., time T₁ in FIG. 8). In one example, Tₘ can be the slot or time-unit of the measurement RS. In one example, Tₘ can be the sub-frame of the measurement RS. In one example, Tₘ can be the frame of the measurement RS. In one example, Tₘ can be the symbol of the measurement RS (e.g., the first symbol of the measurement RS, or the last symbol of the measurement RS, or a symbol of the measurement RS). In one example, Tₘ can be the start of the slot or time-unit of the measurement RS. In one example, Tₘ can be the end of the slot or time-unit of the measurement RS. In one example, Tₘ can be the start of the sub-frame of the measurement RS. In one example, Tₘ can be the end of the sub-frame of the measurement RS. In one example, Tₘ can be the start of the frame of the measurement RS. In one example, Tₘ can be the end of the frame of the measurement RS. In one example, Tₘ can be the start of a symbol of the measurement RS. In one example, Tₘ can be the end of a symbol of the measurement RS. In one example, the time period over which iₙ is valid is one of (1) Tₘ< (or ≤) t< (or ≤) Tₘ+T, (2) Tₘ−T< (or ≤) t< (or ≤) Tₘ, (3) Tₘ−Tₐ< (or ≤) t< (or ≤) Tₘ+T_{b}.

In one example, let Tᵣ be the time of measurement report (e.g., as shown in FIG. 8). In one example, Tᵣ can be the slot or time-unit of the measurement report. In one example, Tᵣ can be the sub-frame of the measurement report. In one example, Tᵣ can be the frame of the measurement report. In one example, Tᵣ can be the symbol of the measurement report (e.g., the first symbol of the measurement report, or the last symbol of the measurement report, or a symbol of the measurement report). In one example, Tᵣ can be the start of the slot or time-unit of the measurement report. In one example, Tᵣ can be the end of the slot or time-unit of the measurement report. In one example, Tᵣ can be the start of the sub-frame of the measurement report. In one example, Tᵣ can be the end of the sub-frame of the measurement report.

In one example, Tᵣ can be the start of the frame of the measurement report. In one example, Tᵣ can be the end of the frame of the measurement report. In one example, Tᵣ can be the start of a symbol of the measurement report. In one example, Tᵣ can be the end of a symbol of the measurement report. In one example, the time period over which iₙ is valid is one of (1) Tᵣ< (or ≤) t< (or ≤) T++T, (2) Tᵣ−T< (or ≤) t< (or ≤) Tᵣ, (3) Tᵣ−Tₐ< (or ≤) t< (or ≤) Tᵣ+T_{b}.

In one example, Tᵣ can be the end of a symbol of the measurement report. In one example, the time period over which iₙ is valid is one of (1) Tₘ< (or ≤) t< (or ≤) Tᵣ+T, (2) Tₘ−T< (or ≤) t< (or ≤) Tᵣ, (3) Tₘ−Tₐ< (or ≤) t< (or ≤) Tᵣ+T_{b}.

In one example, T and/or Tₐ and/or T_{b} is specified in the system specification. In one example T and/or Tₐ and/or T_{b} is configured/updated by higher layer signaling, e.g., RRC signaling. In one example, T and/or Tₐ and/or T_{b} can be configured and/or updated by MAC CE signaling and/or L1 control signaling, e.g., DCI signaling. In one example, a default value for T and/or Tₐ and/or T_{b} is used (e.g., specified in the system specification) if T and/or Tₐ and/or T_{b} is not configured/updated by RRC signaling and/or MAC CE signaling and/or L1 control signaling. In one example, T and/or Tₐ and/or T_{b} is reported by the UE in the measurement report. In one example, T and/or Tₐ and/or T_{b} is reported by the UE in a message separate from the measurement report.

In one example, the time period (e.g., T and/or Tₐ and/or T_{b}) associated with each quality indicator, can depend on the quality indictor index, e.g., different CSI report groups can be associated with different values of time periods.

In another example, associated with each CSI report group #n is a rate of change indicator #n (Rₙ). This is shown in TABLE 3.

TABLE 3
CSI report group

| CSI Report Group Number | Resource Indicator | Quality Metric | Rate of change |
|---|---|---|---|
| CSI Report group #1 | Resource Indicator#1 | Quality Metric#1 | Rate of change#1 |
| CSI Report group #2 | Resource Indicator#2 | Quality Metric#2 | Rate of change#2 |
| . . . | . . . | . . . | . . . |
| CSI Report group #N | Resource Indicator#N | Quality Metric#N | Rate of change#N |

In one example, the rate of change field can have n-bits.

In one example, the rate of change field can indicate a positive rate of change or a negative rate of change. For example, the rate of change can be expressed a two's complement number or a one's complement.

In one example, the rate of change field can indicate a zero rate of change.

In one example, a special value can be reserved to indicate that the rate of change is undetermined. For example, this special value can be “1000 . . . ” or “1111 . . . ” or “0000 . . . ” . . . .

In one example, a single rate of change field R is provided in the measurement report.

In one example, R applies to all quality metrics in the measurement report.

In one example, R applies to the first quality metric (e.g., for CSI Report group #1) in the measurement report.

In one example, R applies to the first M quality metrics in the measurement report. In one example, M is specified in the system specification. In one example M is configured/updated by higher layer signaling, e.g., RRC signaling. In one example, M can be configured and/or updated by MAC CE signaling and/or L1 control signaling, e.g., DCI signaling. In one example, a default value for M is used (e.g., specified in the system specification) if M is not configured/updated by RRC signaling and/or MAC CE signaling and/or L1 control signaling. In one example, M is reported by the UE in the measurement report. In one example, M is reported by the UE in a message separate from the measurement report.

In one example, Rₙ (or R) is valid (e.g., the Rₙ (or R) is applicable) over a time period, T or time periods time periods Tₐ and T_{b}. The previous examples for T and Tₐ and T_{b} apply here.

In one example, let Tₘ be the time of measurement (e.g., time T₁ in FIG. 8). In one example, Tₘ can be the slot or time-unit of the measurement RS. In one example, Tₘ can be the sub-frame of the measurement RS. In one example, Tₘ can be the frame of the measurement RS. In one example, Tₘ can be the symbol of the measurement RS (e.g., the first symbol of the measurement RS, or the last symbol of the measurement RS, or a symbol of the measurement RS). In one example, Tₘ can be the start of the slot or time-unit of the measurement RS. In one example, Tₘ can be the end of the slot or time-unit of the measurement RS. In one example, Tₘ can be the start of the sub-frame of the measurement RS. In one example, Tₘ can be the end of the sub-frame of the measurement RS. In one example, Tₘ can be the start of the frame of the measurement RS. In one example, Tₘ can be the end of the frame of the measurement RS. In one example, Tₘ can be the start of a symbol of the measurement RS. In one example, Tₘ can be the end of a symbol of the measurement RS. In one example, the time period over which iₙ is valid is one of (1) Tₘ< (or ≤) t< (or ≤) Tₘ+T, (2) Tₘ−T< (or ≤) t< (or ≤) Tₘ, (3) Tₘ−Tₐ< (or ≤) t< (or ≤) Tₘ+T_{b}.

In one example, let Tᵣ be the time of measurement report (e.g., as shown in FIG. 8). In one example, Tᵣ can be the slot or time-unit of the measurement report. In one example, Tᵣ can be the sub-frame of the measurement report. In one example, Tᵣ can be the frame of the measurement report. In one example, Tᵣ can be the symbol of the measurement report (e.g., the first symbol of the measurement report, or the last symbol of the measurement report, or a symbol of the measurement report). In one example, Tᵣ can be the start of the slot or time-unit of the measurement report. In one example, Tᵣ can be the end of the slot or time-unit of the measurement report. In one example, Tᵣ can be the start of the sub-frame of the measurement report. In one example, Tᵣ can be the end of the sub-frame of the measurement report. In one example, Tᵣ can be the start of the frame of the measurement report. In one example, Tᵣ can be the end of the frame of the measurement report. In one example, Tᵣ can be the start of a symbol of the measurement report. In one example, Tᵣ can be the end of a symbol of the measurement report. In one example, the time period over which iₙ is valid is one of (1) Tᵣ< (or ≤) t< (or ≤) T++T, (2) Tᵣ−T< (or ≤) t< (or ≤) Tᵣ, (3) Tᵣ−Tₐ< (or ≤) t< (or ≤) T++T_{b}.

In one example, Tᵣ can be the end of a symbol of the measurement report. In one example, the time period over which iₙ is valid is one of (1) Tₘ< (or ≤) t< (or ≤) Tᵣ+T, (2) Tₘ−T< (or ≤) t< (or ≤) T, (3) Tₘ−Tₐ< (or ≤) t< (or ≤) T++T_{b}.

In one example, T and/or Tₐ and/or T_{b} is specified in the system specification. In one example T and/or Tₐ and/or T_{b} is configured/updated by higher layer signaling, e.g., RRC signaling. In one example, T and/or Tₐ and/or T_{b} can be configured and/or updated by MAC CE signaling and/or L1 control signaling, e.g., DCI signaling. In one example, a default value for T and/or Tₐ and/or T_{b} is used (e.g., specified in the system specification) if T and/or Tₐ and/or T_{b} is not configured/updated by RRC signaling and/or MAC CE signaling and/or L1 control signaling. In one example, T and/or Tₐ and/or T_{b} is reported by the UE in the measurement report. In one example, T and/or Tₐ and/or T_{b} is reported by the UE in a message separate from the measurement report.

In one example, the time period (e.g., T and/or Tₐ and/or T_{b}) associated with each quality indicator, can depend on the quality indictor index, e.g., different CSI report groups can be associated with different values of time periods.

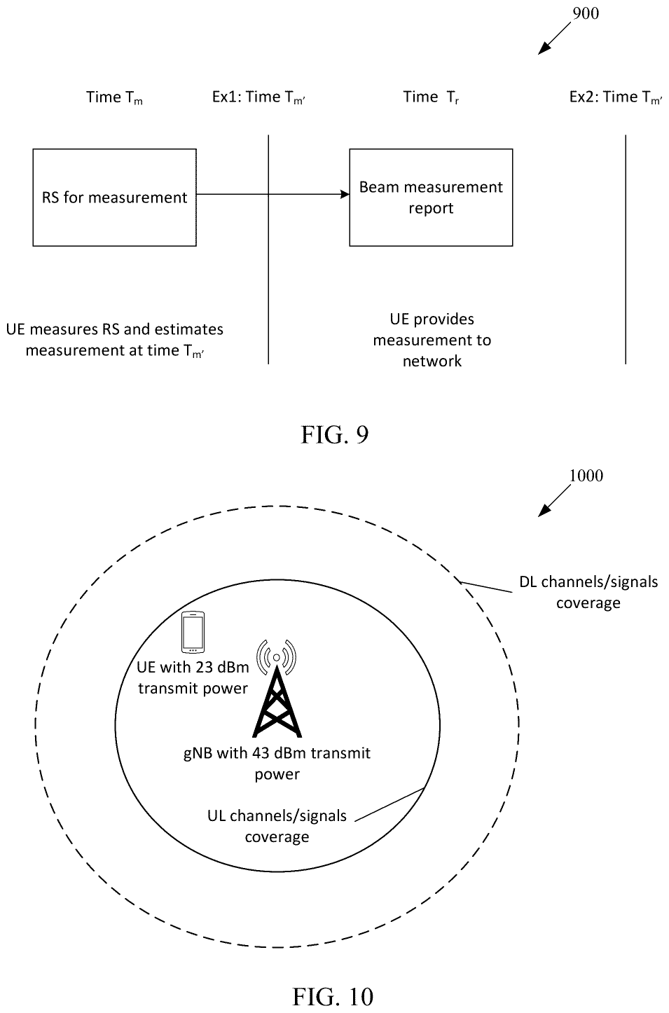

FIG. 9 illustrates an example of UE measurement 900 according to embodiments of the present disclosure. An embodiment of the UE measurement 900 shown in FIG. 9 is for illustration only.

In one example, as illustrated in FIG. 9, a UE is configured to measure the channel (e.g., determine a quality metric) at time Tₘ for a measurement RS (e.g., CSI-RS or SSB) transmitted at time Tₘ. The UE is further configured to estimate the quality metric (e.g., the quality metric can be RSRP (e.g., L1 RSRP or SINR or L3 RSRP, as aforementioned) at time T_{m′}. The UE can provide in the measurement report the transmitted at time Tᵣ, the quality metric at time T_{m′}. In one example, as illustrated in FIG. 9, with “Ex1,” T_{m′} can be before Tᵣ. In another example, as illustrated in FIG. 9, with “Ex2,” T_{m′} can be after Tᵣ. In other example, T_{m′} can equal Tᵣ.

In one example, the time of the estimated quality metric is determined by network, e.g., by configuring or updating Tₐ and/or T_{b}.

In one example, T_{m′}=Tₐ.

In one example, T_{m′}=Tₘ+Tₐ.

In one example, Tₘ=min (Tₘ+Tₐ, Tᵣ).

In one example, T_{m′}=max (Tₘ+Tₐ, Tᵣ).

In one example, T_{m′}=Tₘ−Tₐ.

In one example, T_{m′}=Tᵣ−T_{b}.

In one example, T_{m′}=max (Tₘ, Tᵣ−T_{b}).

In one example, T_{m′}=min (Tₘ, Tᵣ−T_{b}).

In one example, T_{m′}=Tᵣ+T_{b}.

In one example, T_{m′}=min (Tₘ+Tₐ, Tᵣ+T_{b}).

In one example, T_{m′}=min (Tₘ+Tₐ, Tᵣ−T_{b}).

In one example, T_{m′}=min (Tₘ−Tₐ, Tᵣ+T_{b}).

In one example, T_{m′}=min (Tₘ−Tₐ, Tᵣ−T_{b}).

In one example, T_{m′}=max (Tₘ+Tₐ, Tᵣ+T_{b}).

In one example, T_{m′}=max (Tₘ+Tₐ, Tᵣ−T_{b}).

In one example, T_{m′}=max (Tₘ−Tₐ, Tᵣ+T_{b}).

In one example, T_{m′}=max (Tₘ−Tₐ, Tᵣ−T_{b}).

In one example, Tₐ and/or T_{b} is specified in the system specification. In one example Tₐ and/or T_{b} is configured/updated by higher layer signaling, e.g., RRC signaling. In one example, Tₐ and/or T_{b} can be configured and/or updated by MAC CE signaling and/or L1 control signaling, e.g., DCI signaling. In one example, a default value for Tₐ and/or T_{b} is used (e.g., specified in the system specification) if Tₐ and/or T_{b} is not configured/updated by RRC signaling and/or MAC CE signaling and/or L1 control signaling.

In one example, a same time (e.g., Tₐ and/or T_{b}) is associated with the quality indicators in a CSI report (e.g., for beam measurement).

In one example, the time (e.g., Tₐ and/or T_{b}) associated with each quality indicator, can depend on the quality indictor index, e.g., different CSI report groups can be configured/updated with different Tₐ and/or T_{b}.

In one example, the time of the estimated quality metric is determined by UE. In one example, the time of the estimated quality metric is determined by UE and satisfies a criteria specified or configured or updated by the network. For example, the criteria for T_{m′} can be or more of the following: (1) T_{m′}> (or ≥) Tₘ; (2) T_{m′}< (or ≤) Tₘ; (3) T_{m′}> (or ≥) Tₘ+Tₐ; (4) Tₘ< (or ≤) Tₘ+Tₐ; (5) T_{m′}> (or ≥) Tₘ−Tₐ; (6) Tₘ< (or ≤) Tₘ−Tₐ; (7) T_{m′}> (or ≥) Tᵣ; (8) Tₘ< (or ≤) Tᵣ; (9) T_{m′}> (or ≥) Tᵣ+T_{b}; (10) Tₘ< (or ≤) Tᵣ+T_{b}; (11) T_{m′}> (or ≥) Tᵣ−T_{b}; and (12) Tₘ< (or ≤) Tᵣ−T_{b}.

In one example, Tₐ and/or T_{b} is specified in the system specification. In one example Tₐ and/or T_{b} is configured/updated by higher layer signaling, e.g., RRC signaling. In one example, Tₐ and/or T_{b} can be configured and/or updated by MAC CE signaling and/or L1 control signaling, e.g., DCI signaling. In one example, a default value for Tₐ and/or T_{b} is used (e.g., specified in the system specification) if Tₐ and/or T_{b} is not configured/updated by RRC signaling and/or MAC CE signaling and/or L1 control signaling.

In one example, a same time (e.g., Tₐ and/or T_{b}) is associated with the quality indicators in a CSI report (e.g., for beam measurement).

In one example, the time (e.g., Tₐ and/or T_{b}) associated with each quality indicator can depend on the quality indictor index, e.g., different CSI report groups can be configured/updated with different Tₐ and/or T_{b}.

In one example (e.g., when the UE determines the time Tₘ), T_{m′} is reported by the UE in the measurement report. In one example (e.g., when the UE determines the time Tₘ)), T_{m′} is reported by the UE in a message separate from the measurement report.

In one example (e.g., when the UE determines the time T_{m′}), a common value is determined for all CSI report groups. The UE can report the common value in the measurement report or in a message separate from the measurement report.

In one example (e.g., when the UE determines the time Tₘ), a separate value can be determined for each CSI report group. The UE can report the value for each CSI report group in the measurement report or in a message separate from the measurement report.

In one example, a CSI report (e.g., for beam measurement) includes N CSI report groups, wherein each CSI report group includes at least: (1) a resource indicator. For example, this can be CRI or SSBRI; or (2) an estimated or predicted quality metric at time T_{m′} associated with the resource indicator. In one example, the estimated quality metric can be RSRP, e.g., L1 RSRP. In one example the estimated quality metric can be SINR. In one example, the estimated quality metric can be L3 RSRP (for example this be L1 RSRP that is long-term averaged, e.g., exponentially averaged or using a sliding window). In one example, the first estimated quality metric is an absolute value. In one example, the first estimated quality metric of the N quality metrics has the largest value. In one example, the remaining N−1 estimated quality metrics (e.g., excluding the first quality metric), are relative to the first estimated quality metric. In one example, all N estimated quality metrics are in absolute value.

In one example, N is specified in the system specification, e.g., N=4. In one example N is configured/updated by higher layer signaling, e.g., RRC signaling. In one example, N can be configured and/or updated by MAC CE signaling and/or L1 control signaling, e.g., L1 control signaling. In one example, a default value for N is used (e.g., specified in the system specification) if N is not configured/updated by RRC signaling and/or MAC CE signaling and/or L1 control signaling. TABLE 4 shows an example of a measurement report with N CSI report groups.

TABLE 4
Measurement report

| | | Estimated Quality |
|---|---|---|
| CSI Report Group Number | Resource Indicator | Metric at T_{m′} |
| CSI Report group #1 | Resource Indicator#1 | Quality Metric#1 |
| CSI Report group #2 | Resource Indicator#2 | Quality Metric#2 |
| . . . | . . . | . . . |
| CSI Report group #N | Resource Indicator#N | Quality Metric#N |

In another example, the time of the measurement T_{m′} is included in the measurement report. In one example, T_{m′} is common to all CSI Report groups and a single value can be included in the measurement report. In another example, T_{m′} can be included for each CSI Report group as shown in TABLE 5. In one example, T_{m′} included in the measurement report is an absolute time (e.g., as a symbol and/or slot and/or time-unit and/or sub-frame and/or frame). In one example, T_{m′} is included as an offset from T_{m′} wherein the value included can be in symbols and/or slots and/or time-units and/or subframes and/or frames. In one example, T_{m′} is included as an offset from Tᵣ, wherein the value included can be in symbols and/or slots and/or time-units and/or subframes and/or frames. In one example, for the first CSI Report group (e.g., CSI Report group #1), the value is an absolute time or an offset from Tₘ or an offset from Tᵣ, as aforementioned, the remaining N−1 values (e.g., from 1 to N−1) are relative to the T_{m′} of CSI Report group #1 in unit of symbols and/or slots and/or time-units and/or subframes and/or frames. In one example, for the first CSI Report group (CSI Report group #1), the value is an absolute time or an offset from Tₘ or an offset from Tᵣ, as aforementioned, for the remaining N−1 values (e.g., from 1 to N−1) T_{m′} T_{m′} of CSI Report group #i is relative to T_{m′} of CSI Report group #(i−1) in unit of symbols and/or slots and/or time-units and/or subframes and/or frames.

TABLE 5
CSI report group

| | | Estimated Quality | Time of |
|---|---|---|---|
| CSI Report Group Number | Resource Indicator | Metric at T_{m′} | measurement T_{m′} |
| CSI Report group #1 | Resource Indicator#1 | Quality Metric#1 | T_{m′}#1 |
| CSI Report group #2 | Resource Indicator#2 | Quality Metric#2 | T_{m′}#2 |
| . . . | . . . | . . . | . . . |
| CSI Report group #N | Resource Indicator#N | Quality Metric#N | T_{m′}#N |

In a variant example, of the example of TABLE 5, time T_{m′} #i (whether absolute or relative to another time) is the time at which the Resource Indicator #i, has the best quality metric.

In another example, of the example of TABLE 5, time T_{m′} #i (whether absolute or relative to another time) is the time at which the Resource Indicator #i, has the best quality metric and the estimate quality metric is not reported. This is illustrated in TABLE 6.

TABLE 6
CSI report group

| | | Time of best |
|---|---|---|
| CSI Report Group Number | Resource Indicator | quality metric T_{m′} |
| CSI Report group #1 | Resource Indicator#1 | T_{m′}#1 |
| CSI Report group #2 | Resource Indicator#2 | T_{m′}#2 |
| . . . | . . . | . . . |
| CSI Report group #N | Resource Indicator#N | T_{m′}#N |

In one example, a CSI report (e.g., for beam measurement) includes N CSI report groups, wherein each CSI report group includes at least: (1) a resource indicator. For example, this can be CRI or SSBRI; (2) a quality metric associated with the resource indicator measured at time Tₘ. In one example, the quality metric can be RSRP, e.g., L1 RSRP. In one example the quality metric can be SINR. In one example, the quality metric can be L3 RSRP (for example this be L1 RSRP that is long-term averaged, e.g., exponentially averaged or using a sliding window). In one example, the first quality metric is an absolute value. In one example, the first quality metric of the N quality metrics has the largest value. In one example, the remaining N−1 quality metrics (e.g., excluding the first quality metric), are relative to the first quality metric. In one example, all N quality metrics are in absolute value; (3) an estimated or predicted quality metric at time T_{m′} associated with the resource indicator. In one example, the estimated quality metric can be RSRP, e.g., L1 RSRP. In one example the estimated quality metric can be SINR. In one example, the estimated quality metric can be L3 RSRP (for example this be L1 RSRP that is long-term averaged, e.g., exponentially averaged or using a sliding window). In one example, the first estimated quality metric is an absolute value. In one example, the first estimated quality metric has the largest value. In one example, the remaining N−1 estimated quality metrics (e.g., excluding the first quality metric), are relative to the first estimated quality metric. In one example, all N estimated quality metrics are in absolute value. In one example, the N quality metrics at time T_{m′} are relative to the first (e.g., largest) quality metric at time Tₘ. In one example, the N quality metrics at time T_{m′} are relative to the respective quality metric at time Tₘ.

In one example, N is specified in the system specification, e.g., N=4. In one example N is configured/updated by higher layer signaling, e.g., RRC signaling. In one example, N can be configured and/or updated by MAC CE signaling and/or L1 control signaling, e.g., DCI signaling. In one example, a default value for N is used (e.g., specified in the system specification) if N is not configured/updated by RRC signaling and/or MAC CE signaling and/or L1 control signaling. TABLE 7 shows an example of a measurement report with N CSI report groups.

TABLE 7
Measurement report

| | | | Estimated Quality |
|---|---|---|---|
| CSI Report Group Number | Resource Indicator | Quality Metric at Tₘ | Metric at T_{m′} |
| CSI Report group #1 | Resource Indicator#1 | Quality Metric#1 | Quality Metric#1 |
| CSI Report group #2 | Resource Indicator#2 | Quality Metric#2 | Quality Metric#2 |
| . . . | . . . | . . . | . . . |
| CSI Report group #N | Resource Indicator#N | Quality Metric#N | Quality Metric#N |

In a further example, the time of the measurement T_{m′} is included in the measurement report. In one example, T_{m′} is common to all CSI Report groups and a single value can be included in the measurement report. In another example, T_{m′} can be included for each CSI Report group as shown in TABLE 8. In one example, T_{m′} included in the measurement report is an absolute time (e.g., as a symbol and/or slot and/or time and/or sub-frame and/or frame). In one example, T_{m′} is included as an offset from Tₘ, wherein the value included can be in symbols and/or slots and/or time-units and/or subframes and/or frames. In one example, T_{m′} is included as an offset from Tᵣ, wherein the value included can be in symbols and/or slots and/or time-units and/or subframes and/or frames. In one example, for the first CSI Report group (e.g., CSI Report group #1), the value is an absolute time or an offset from Tₘ or an offset from Tᵣ, as aforementioned, the remaining N−1 values (e.g., from 1 to N−1) are relative to the T_{m′} of CSI Report group #1 in unit of symbols and/or slots and/or time-units and/or subframes and/or frames. In one example, for the first CSI Report group (CSI Report group #1), the value is an absolute time or an offset from Tₘ or an offset from Tᵣ, as aforementioned, for the remaining N−1 values (e.g., from 1 to N−1) Tₘ T_{m′} of CSI Report group #i is relative to T_{m′} of CSI Report group #(i−1) in unit of symbols and/or slots and/or time-units and/or subframes and/or frames.

TABLE 8
CSI report group

| | | | Estimated Quality | Time of |
|---|---|---|---|---|
| CSI Report Group Number | Resource Indicator | Quality Metric at Tₘ | Metric at T_{m′} | measurement T_{m′} |
| CSI Report group #1 | Resource Indicator#1 | Quality Metric#1 | Quality Metric#1 | T_{m′}#1 |
| CSI Report group #2 | Resource Indicator#2 | Quality Metric#2 | Quality Metric#2 | T_{m′}#2 |
| . . . | . . . | . . . | . . . | . . . |
| CSI Report group #N | Resource Indicator#N | Quality Metric#N | Quality Metric#N | T_{m′}#N |

In a variant example, of the example of TABLE 8, time T_{m′} #i (whether absolute or relative to another time) is the time at which the Resource Indicator #i, has the best quality metric.

In one example, of the example of TABLE 8, time T_{m′} #i (whether absolute or relative to another time) is the time at which the Resource Indicator #i, has the best quality metric and the estimate quality metric is not reported. This is illustrated in TABLE 9.

TABLE 9
CSI report group

| | | | Time of best |
|---|---|---|---|
| CSI Report Group Number | Resource Indicator | Quality Metric at Tₘ | quality metric T_{m′} |
| CSI Report group #1 | Resource Indicator#1 | Quality Metric#1 | T_{m′}#1 |
| CSI Report group #2 | Resource Indicator#2 | Quality Metric#2 | T_{m′}#2 |
| . . . | . . . | . . . | . . . |
| CSI Report group #N | Resource Indicator#N | Quality Metric#N | T_{m′}#N |

In another example, a CSI report (e.g., for beam measurement) includes N CSI report groups, wherein each CSI report group includes at least: (1) a resource Indicator. For example, this can be CRI or SSBRI; (2) a quality metric associated with the resource indicator. In one example, the quality metric can be RSRP, e.g., L1 RSRP. In one example the quality metric can be SINR. In one example, the quality metric can be L3 RSRP (for example this be L1 RSRP that is long-term averaged, e.g., exponentially averaged or using a sliding window). In one example, the first quality metric of the N quality metrics is an absolute value. In one example, the first quality metric has the largest value.

In one example, the remaining N−1 quality metrics (e.g., excluding the first quality metric), are relative to the first quality metric. In one example, all N quality metrics are in absolute value; or (3) a time metric associated with the resource indicator. In one example, the time metric is the time at which (or after which) the resource indicator is not recommended to be used. In one example, the time metric is the time at which (or up to which) the resource indicator can be used. In one example, the time metric for a CSI report group is a first-time metric and a second time metric, wherein the resource indicator of a CSI report group can be used between the first-time and the second time metric of the CSI report group. In one example, the time metric for a CSI report group is a first-time metric and a second time metric, wherein the resource indicator of a CSI report group is recommended not to be used between the first-time and the second time metric of the CSI report group. In one example, the time metric included in the measurement report is an absolute time (e.g., as a symbol and/or slot and/or time-unit and/or sub-frame and/or frame).

In one example, the time metric is included as an offset from Tₘ (the time of measurement), wherein the value included can be in symbols and/or slots and/or time-units and/or subframes and/or frames. In one example, the time metric is included as an offset from Tᵣ (the time of the measurement report), wherein the value included can be in symbols and/or slots and/or time-units and/or subframes and/or frames. In one example, for the first CSI Report group (CSI Report group #1), the value is an absolute time or an offset from Tₘ or an offset from Tᵣ, as aforementioned, the remaining N−1 values (e.g., from 1 to N−1) are relative to the time metric of CSI Report group #1 in unit of symbols and/or slots and/or time-units and/or subframes and/or frames. In one example, for the first CSI Report group (CSI Report group #1), the value is an absolute time or an offset from Tₘ or an offset from Tᵣ, as aforementioned, for the remaining N−1 values (e.g., from 1 to N−1) of the time metric, the time metric of CSI Report group #i is relative to the time metric of CSI Report group #(i−1) in unit of symbols and/or slots and/or time-units and/or subframes and/or frames.

In one example, if a time metric for CSI report group #i includes a first-time metric and a second time metric one or more of the following examples can apply.

In one example, the first-time metric is an absolute time metric in unit of symbols and/or slots and/or time-units and/or subframes and/or frames.

In one example, the second time metric is an absolute time metric in unit of symbols and/or slots and/or time-units and/or subframes and/or frames.

In one example, the second time metric is relative to the first-time metric in unit of symbols and/or slots and/or time-units and/or subframes and/or frames.

In one example, the first-time metric for CSI report group #i (e.g., for i between 2 and N) is relative to the first-time metric for CSI report group #1 in unit of symbols and/or slots and/or time-units and/or subframes and/or frames.

In one example, the second time metric for CSI report group #i (e.g., for i between 2 and N) is relative to the second time metric for CSI report group #1 in unit of symbols and/or slots and/or time-units and/or subframes and/or frames.

In one example, the second time metric for CSI report group #i (e.g., for i between 2 and N) is relative to the first-time metric for CSI report group #1 in unit of symbols and/or slots and/or time-units and/or subframes and/or frames.

In one example, the first-time metric for CSI report group #i (e.g., for i between 2 and N) is relative to the first-time metric for CSI report group #(i−1) in unit of symbols and/or slots and/or time-units and/or subframes and/or frames.

In one example, the second time metric for CSI report group #i (e.g., for i between 2 and N) is relative to the second time metric for CSI report group #(i−1) in unit of symbols and/or slots and/or time-units and/or subframes and/or frames.

In one example, the second time metric for CSI report group #i (e.g., for i between 2 and N) is relative to the first-time metric for CSI report group #(i−1) in unit of symbols and/or slots and/or time-units and/or subframes and/or frames.

In one example, the roles of the first metric and the second metric in the previously mentioned examples can be reversed.

In one example, N is specified in the system specification, e.g., N=4. In one example N is configured/updated by higher layer signaling, e.g., RRC signaling. In one example, N can be configured and/or updated by MAC CE signaling and/or L1 control signaling, e.g., DCI signaling. In one example, a default value for N is used (e.g., specified in the system specification) if N is not configured/updated by RRC signaling and/or MAC CE signaling and/or L1 control signaling. TABLE 10 shows an example of a measurement report with N CSI report groups.

TABLE 10
Measurement report

| CSI Report Group Number | Resource Indicator | Quality Metric | Time Metric |
|---|---|---|---|
| CSI Report group #1 | Resource Indicator#1 | Quality Metric#1 | Time Metric#1 |
| CSI Report group #2 | Resource Indicator#2 | Quality Metric#2 | Time Metric#2 |
| . . . | . . . | . . . | . . . |
| CSI Report group #N | Resource Indicator#N | Quality Metric#N | Time Metric#N |

In another example, a CSI report (e.g., for beam measurement) includes N CSI report groups, wherein each CSI report group includes at least: (1) a resource indicator. For example, this can be CRI or SSBRI; or (2) a time metric associated with the resource indicator. In one example, the time metric is the time at which (or after which) the resource indicator is not recommended to be used. In one example, the time metric is the time at which (or up to which) the resource indicator can be used. In one example, the time metric for a CSI report group is a first-time metric and a second time metric, wherein the resource indicator of a CSI report group can be used between the first-time and the second time metric of the CSI report group. In one example, the time metric for a CSI report group is a first-time metric and a second time metric, wherein the resource indicator of a CSI report group is recommended not to be used between the first-time and the second time metric of the CSI report group. In one example, the time metric included in the measurement report is an absolute time (e.g., as a symbol and/or slot and/or time-unit and/or sub-frame and/or frame). In one example, the time metric is included as an offset from Tₘ (the time of measurement), wherein the value included can be in symbols and/or slots and/or time-units and/or subframes and/or frames. In one example, the time metric is included as an offset from Tᵣ (the time of the measurement report), wherein the value included can be in symbols and/or slots and/or time-units and/or subframes and/or frames.

In one example, for the first CSI Report group (CSI Report group #1), the value is an absolute time or an offset from Tₘ or an offset from Tᵣ, as aforementioned, the remaining N−1 values (e.g., from 1 to N−1) are relative to the time metric of CSI Report group #1 in unit of symbols and/or slots and/or time-units and/or subframes and/or frames. In one example, for the first CSI Report group (CSI Report group #1), the value is an absolute time or an offset from Tₘ or an offset from Tᵣ, as aforementioned, for the remaining N−1 values (e.g., from 1 to N−1) of the time metric, the time metric of CSI Report group #i is relative to the time metric of CSI Report group #(i−1) in unit of symbols and/or slots and/or time-units and/or subframes and/or frames.

In one example, if a time metric for CSI report group #i includes a first-time metric and a second time metric one or more of the following examples can apply.

In one example, the first-time metric is an absolute time metric in unit of symbols and/or slots and/or time-units and/or subframes and/or frames.

In one example, the second time metric is an absolute time metric in unit symbols and/or slots and/or time-units and/or subframes and/or frames.

In one example, the second time metric is relative to the first-time metric in unit of symbols and/or slots and/or time-units and/or subframes and/or frames.

In one example, the first-time metric for CSI report group #i (e.g., for i between 2 and N) is relative to the first-time metric for CSI report group #1 in unit of symbols and/or slots and/or time-units and/or subframes and/or frames.

In one example, the second time metric for CSI report group #i (e.g., for i between 2 and N) is relative to the second time metric for CSI report group #1 in unit of symbols and/or slots and/or time-units and/or subframes and/or frames.

In one example, the second time metric for CSI report group #i (e.g., for i between 2 and N) is relative to the first-time metric for CSI report group #1 in unit of symbols and/or slots and/or time-units and/or subframes and/or frames.

In one example, the first-time metric for CSI report group #i (e.g., for i between 2 and N) is relative to the first-time metric for CSI report group #(i−1) in unit of symbols and/or slots and/or time-units and/or subframes and/or frames.

In one example, the second time metric for CSI report group #i (e.g., for i between 2 and N) is relative to the second time metric for CSI report group #(i−1) in unit of symbols and/or slots and/or time-units and/or subframes and/or frames.

In one example, the second time metric for CSI report group #i (e.g., for i between 2 and N) is relative to the first-time metric for CSI report group #(i−1) in unit of symbols and/or slots and/or time-units and/or subframes and/or frames.

In one example, the roles of the first metric and the second metric in the previously mentioned examples can be reversed.

In one example, N is specified in the system specification, e.g., N=4. In one example N is configured/updated by higher layer signaling, e.g., RRC signaling. In one example, N can be configured and/or updated by MAC CE signaling and/or L1 control signaling, e.g., DCI signaling. In one example, a default value for N is used (e.g., specified in the system specification) if N is not configured/updated by RRC signaling and/or MAC CE signaling and/or L1 control signaling. TABLE 11 shows an example of a measurement report with N CSI report groups.

TABLE 11
Measurement report

| CSI Report Group Number | Resource Indicator | Time Metric |
|---|---|---|
| CSI Report group #1 | Resource Indicator#1 | Time Metric#1 |
| CSI Report group #2 | Resource Indicator#2 | Time Metric#2 |
| . . . | . . . | . . . |
| CSI Report group #N | Resource Indicator#N | Time Metric#N |

The present disclosure includes: (1) a predictive beam reporting from the UE; (2) an indication of whether a beam metric will get better or worse over time or a rate of change of a measurement quantity; (3) measurement at a future time; and (4) a measurement report can include a time metric corresponding to a resource indicator.

In this disclosure, a beam is determined by either of: (1) a TCI state, that establishes a quasi-colocation (QCL) relationship or spatial relation between a source reference signal (e.g., SSB and/or CSI-RS) and a target reference signal; or (2) a spatial relation information that establishes an association to a source reference signal, such as SSB or CSI-RS or SRS. In either case, the ID of the source reference signal or TCI state or spatial relation identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

The unified (master or main or indicated) TCI state is TCI state of UE-dedicated reception on PDSCH/PDCCH or dynamic-grant/configured-grant based PUSCH and all of dedicated PUCCH resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a PCI different from the PCI of the serving cell (e.g., the TCI state is associated with a TRP of a cell having a PCI different from the PCI of the serving cell).

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g., non-UE dedicated channel and SRS.

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI Format can be with a DL assignment or without a DL assignment.

A TCI state (TCI state code point) indicated in a DL related DCI format is applied after a beam application time from the corresponding HARQ-ACK feedback. A TCI state codepoint can include: (1) a joint TCI state for DL and UL transmissions, (2) a DL TCI state for DL transmissions, (3) an UL TCI state for UL transmissions, or (4) a pair of (a) DL TCI state for DL transmissions and (b) UL TCI state for UL transmissions.

In this disclosure, UL TRP including, initial beam acquisition for UL TRP, source reference signal for UL TCI state associated with UL TRP and power control and time advance aspects is provided.

In release 15/16, a common framework is shared for CSI and beam management, while the complexity of such framework is justified for CSI in FR1, the framework makes beam management procedures rather cumbersome, and less efficient in FR2. Efficiency here refers to overhead associated with beam management operations and latency for reporting and indicating new beams.

Furthermore, in release 15 and release 16, the beam management framework is different for different channels. This increases the overhead of beam management and could lead to less robust beam-based operation. For example, for PDCCH the TCI state (used for beam indication), is updated through MAC CE signaling. While the TCI state of PDSCH can be updated through a DL DCI carrying the DL assignment with codepoints configured by MAC CE, the PDSCH TCI state can follow that of the corresponding PDCCH, or use a default beam indication. In the uplink direction, the spatialRelationInfo framework is used for beam indication for PUCCH and SRS, which is updated through RRC and MAC CE signaling. For PUSCH the SRI (SRS resource indicator), in an UL DCI with UL grants, can be used for beam indication. Having different beam indications and beam indication update mechanisms increases the complexity, overhead and latency of beam management, and could lead to less robust beam-based operation.

Rel-17 introduced the unified TCI framework, wherein a unified or master or main TCI state is signaled to the UE. RRC signaling configures Rel-17 TCI states (TCI-state_r17). MAC signaling can activate one or more TCI codepoints. When one TCI state codepoint is activated by MAC CE, the UE applies the TCI state(s) associated with the activated codepoint after a beam application time. When more than one TCI codepoints are activated by MAC CE, further DCI signaling is used to indicate a TCI state codepoint to the UE. The unified TCI state can be signaled by a DCI Format (e.g., DL related DCI Format (e.g., DCI Format 1_1 or DCI Format 1_2) with a DL assignment or a DL related DCI Format (e.g., DCI Format 1_1 or DCI Format 1_2) without a DL assignment.

FIG. 10 illustrates an example of transmission power 1000 according to embodiments of the present disclosure. An embodiment of the transmission power 1000 shown in FIG. 10 is for illustration only.

In some embodiments, the coverage of a wireless network is limited by the coverage of UL channels and signals, as a result of limited UL transmit power from the UE. In one example, as illustrated in FIG. 10, the transmission power from the base station (gNB) can be 43 dBm, while the transmission power from the user equipment can be 23 dBm potentially limiting the coverage of uplink channels and signals. While more robust channel coding for UL channels and more advanced base station receivers can improve uplink coverage, this is not enough to bridge the gap between uplink and downlink coverage.

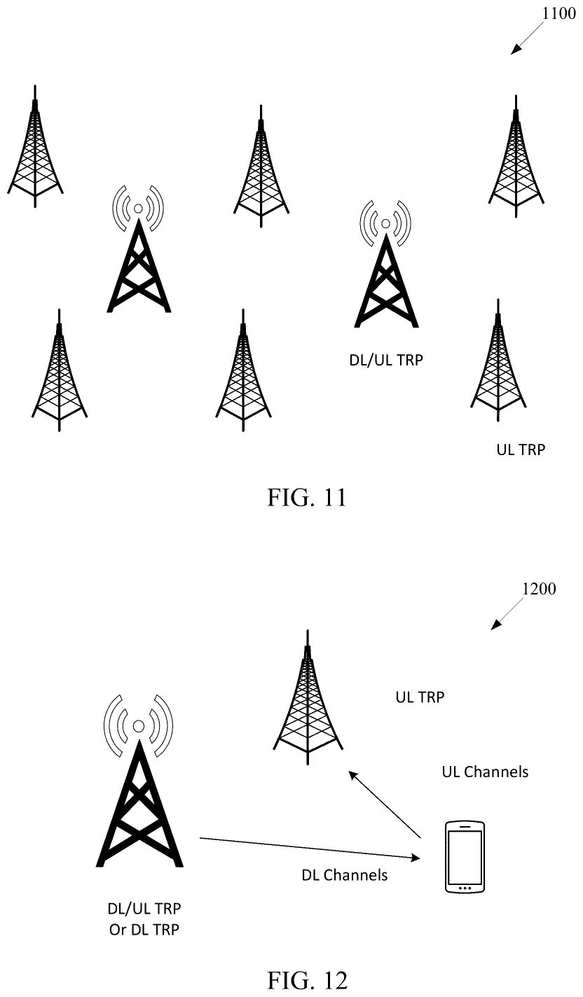

FIG. 11 illustrates an example of TRPs 1100 according to embodiments of the present disclosure. An embodiment of the TRPs 1100 shown in FIG. 11 is for illustration only.

One way to address this issue is to have denser uplink deployments. The uplink TRPs are placed at a closer distance to UE, hence addressing the issues of uplink coverage. An example of such deployment is illustrated in FIG. 11. In FIG. 11, some TRPs serve and DL and UL TRPs, while other TRPs only serve as uplink TRPs. The uplink TRPs can be densely placed. In a variant of this network architecture, the network can consist of sparsely placed DL TRPs and densely placed UL TRPs. In another variant of this network architecture, the network can consist of sparsely placed DL TRPs or DL/UL TRPs and densely placed UL TRPs.

FIG. 12 illustrates an example of network architecture for TRPs 1200 according to embodiments of the present disclosure. An embodiment of the network architecture for TRPs 1200 shown in FIG. 12 is for illustration only.

As a result of this network architecture, a situation may arise where a UE receives DL channels from one TRP and transmits UL channels to another TRP as illustrated in FIG. 12. There are a few implications of this as shown below.

DL channels and UL channels are received and transmitted at the UE on different beams (different spatial domain transmission filters). This can be handled by configuring the UE with separate TCI states, i.e., a DL TCI state for DL channels and signals and an UL TCI state for UL channels and signals as aforementioned.

In one example, the source RS of the TCI state for UL transmissions (UL channels and/or signals) to the UL TRP is provided. The UL TRP may not be transmitting any DL transmissions, hence there may be no SSB transmissions or CSI-RS transmissions for the UL TRP. Hence, the source RS for the UL TCI states associated with the UL TRP can be an uplink signal transmitted from the UE. This is further considered in this disclosure.

In one example, the power of UL transmissions to the UL TRP is provided. In NR, the power control for UL transmissions is based on a pathloss measured between the TRP and UE. The pathloss is measured using a PL-RS, wherein the PL-RS is a DL periodic reference signal (e.g., SSB and/or NZP CSI-RS). As the UL TRP may not be transmitting DL reference signals, a different signal (e.g., transmitted from the UE) can be used for power control. This is further considered in this disclosure.

In one example, the timing of UL transmissions to the UL TRP is provided. In NR, the time advance for UL transmissions is relative to a DL signal received from the target TRP. As there are no DL signals transmitted from the UL TRP, a different reference source can be considered for UL transmissions to the UL TRP. This is further considered in this disclosure.

In one example, the UL TRP is associated with a same cell (e.g., same PCI) as that of the DL/UL TRP or DL TRP.

In one example, the UL TRP is associated with a different cell (e.g., different PCI) from that of the DL/UL TRP or DL TRP.

In one example, the UL TRP has no cell or PCI associated with it.

In this disclosure, the following aspects are provided for transmissions to an UL TRP: (1) initial beam acquisitioning for UL TRP; or (2) the source reference signal for UL TCI states associated with the UL TRP.

The present disclosure relates to a 5G/NR communication system.

This disclosure provides aspects related to UL transmissions to an UL TRP, e.g., for dense UL deployments. The following components are provided: (1) initial beam acquisitioning for UL TRP; and/or (2) the source reference signal for UL TCI states associated with the UL TRP.

In this disclosure, an RRC signaling (e.g., configuration by RRC signaling) includes the following: (1) system information block (SIB)-based RRC signaling (e.g., SIB1 or other SIB) and/or (2) RRC dedicated signaling that is sent to a specific UE.

In this disclosure, MAC CE signaling includes: (1) DL MAC CE signaling from a gNB or network to a UE, when transmitted by the gNB, and/or (2) UL MAC CE signaling from a UE to a gNB when transmitted from the UE.

In this disclosure, L1 control signaling includes: (1) DL control information (e.g., DCI on PDCCH) when transmitted from a gNB or network to a UE, and/or (2) UL control information (e.g., UCI on PUCCH or PUSCH) when transmitted from a UE.

Terminology such as TCI, TCI states, SpatialRelationInfo, target RS, reference RS, and other terms are used for illustrative purposes and are therefore not normative. Other terms that refer to same functions can also be used.

As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE.

In the following components, a TCI state is used for a beam indication. The TCI state can refer to a DL TCI state for downlink channels (e.g., PDCCH and PDSCH), an uplink TCI state for uplink channels (e.g., PUSCH or PUCCH), a joint TCI state for downlink and uplink channels, or separate TCI states for uplink and downlink channels. A TCI state can be common across multiple component carriers or can be a separate TCI state for a component carrier or a set of component carriers. A TCI state can be gNB or UE panel specific or common across panels. In some examples, the uplink TCI state can be replaced by SRS resource indicator (SRI).

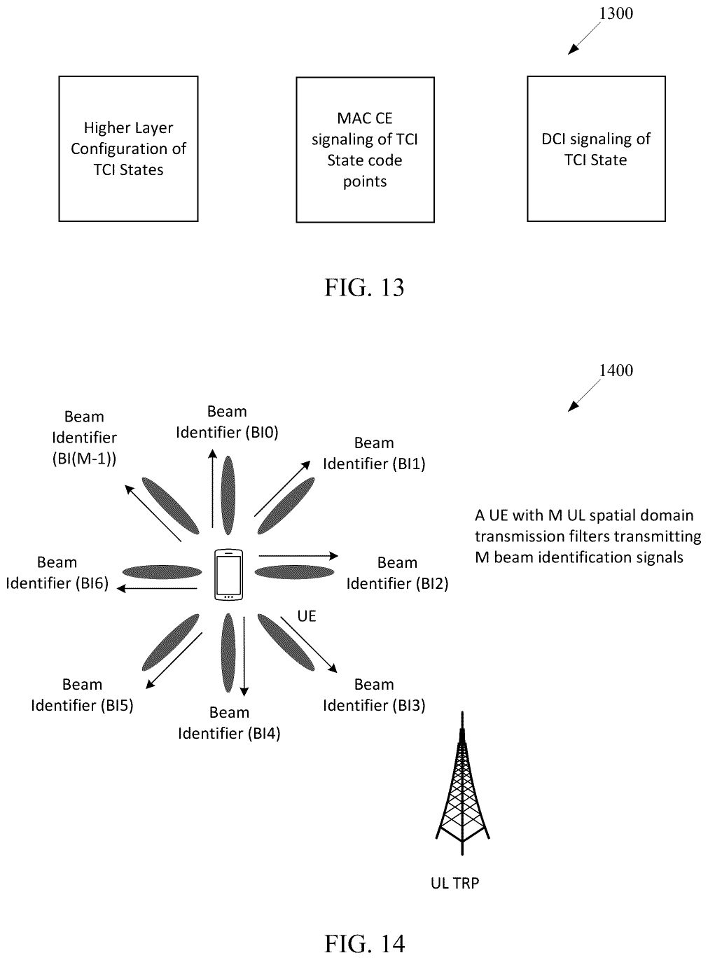

FIG. 13 illustrates an example of UE configuration 1300 according to embodiments of the present disclosure. An embodiment of the UE configuration 1300 shown in FIG. 13 is for illustration only.

In the following examples, as illustrated in FIG. 13, a UE is configured/updated through a higher layer RRC signaling, a set of TCI states with L elements. In one example, DL and joint TCI states are configured by a higher layer parameter DLorJoint-TCIState, wherein a number of DL and joint TCI state is L_{DJ}. UL TCI state is configured by a higher layer parameter UL-TCIState, wherein a number of UL TCI state is L_{U}. L=L_{DJ}+L_{U}, wherein L is the total number of DL, joint and UL TCI states.

MAC CE signaling includes a subset of K (K≤L) TCI states or TCI state code points from the set of L TCI states, wherein a code point is signaled in the “transmission configuration indication” field of a DCI used for indication of the TCI state. A codepoint can include one TCI state (e.g., DL TCI state or UL TCI state or Joint (DL and UL) TCI state). Alternatively, a codepoint can include two TCI states (e.g., a DL TCI state and an UL TCI state). L1 control signaling (i.e., downlink control information (DCI)) updates the UE's TCI state, wherein the DCI includes a “transmission configuration indication” (beam indication) field e.g., with k bits (such that K≤2k), the TCI state corresponds to a code point signaled by MAC CE. A DCI used for indication of the TCI state can be DL related DCI Format (e.g., DCI Format 1_1 or DCI Format 1_2), with a DL assignment or without a DL assignment.

The TCI states can be associated, through a QCL relation, with an SSB of serving cell, or an SSB associated with a PCI different from the PCI of the serving cell. The QCL relation with a SSB can be a direct QCL relation, wherein the source RS (e.g., for a QCL Type D relation or a spatial relation) of the QCL state is the SSB. The QCL relation with a SSB can be an indirect QCL relation, wherein, the source RS (e.g., for a QCL Type D relation or a spatial relation) can be a reference signal, and the reference signal has the SSB as its source (e.g., for a QCL Type D relation or a spatial relation). The indirect QCL relation to an SSB can involve a QCL or spatial relation chain of more than one reference signal.

The UE can use a DL related DCI (e.g., DCI Format 1_1 or DCI Format 1_2) without DL assignment, for a beam indication. For example, the use of DL related DCI without DL assignment can be configured by higher layers or can be specified in the system specification.

Alternatively, the UE can use a DL related DCI (e.g., DCI Format 1_1 or DCI Format 1_2) with DL assignment, for beam indication. For example, the use of DL related DCI with DL assignment can be configured by higher layers or can be specified in the system specification.

In the following examples, the “transmission configuration indication” provided by a DCI format includes a TCI state codepoint activated by MAC CE. Wherein, the TCI state codepoint can be one of: (1) joint TCI state used for UL transmissions and DL receptions by the UE; and (2) a DL TCI state used for DL receptions by the UE; (3) a UL TCI state used for UL transmissions by the UE; and (4) a DL TCI state used for DL receptions by the UE and UL TCI state used for UL transmissions by the UE.

FIG. 14 illustrates an example of spatial domain transmission 1400 according to embodiments of the present disclosure. An embodiment of the spatial domain transmission 1400 shown in FIG. 14 is for illustration only.

In one example, a UE can have M UL spatial domain transmission filters (e.g., M UL beams) as illustrated in FIG. 14. For example, a UE can transmit in M different directions. In one example, M is indicated by the UE to the network. In one example M is determined based on a UE capability. In one example, M is configured by the network.

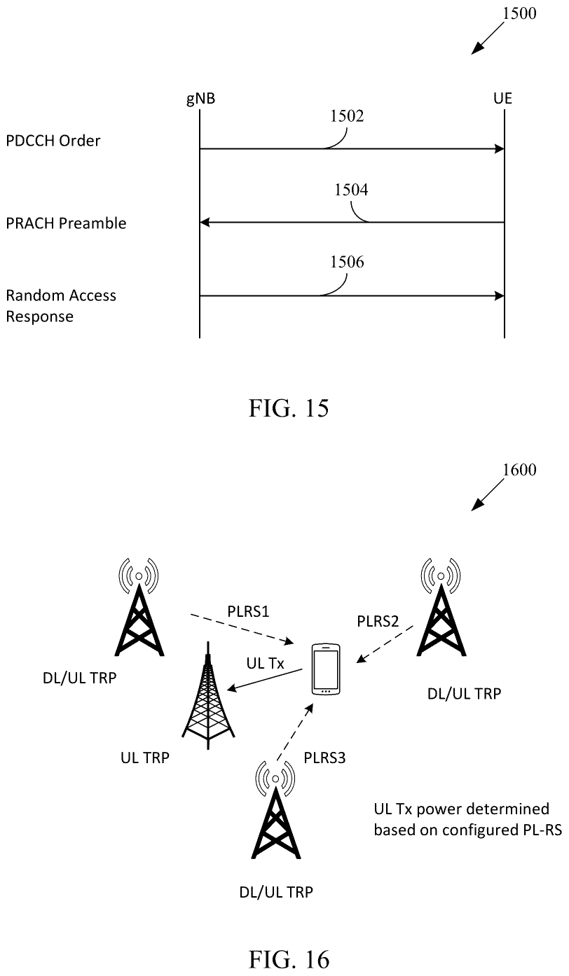

FIG. 15 illustrates an example of signaling flow 1500 for RACH operation according to embodiments of the present disclosure. The signaling flow 1500 as may be performed by a UE (e.g., 111-116 as illustrated in FIG. 1) and a base station (e.g., 101-103 as illustrated in FIG. 1). An embodiment of the signaling flow 1500 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

As illustrated in FIG. 15, in step 1502, a gNB sends a PDCCH order to a UE. In step 1504, the UE sends a PRACH preamble in response to receiving the PDCCH order. In step 1506, the gNB sends a random access response to the UE in response to receiving the PRACH preamble.

In one example, the UE transmits a beam identifier signal associated with each UL spatial domain transmission filter. In one example, a beam identifier signal can be a PRACH preamble. In one example, a beam identifier signal can be SRS.

In one example, a PDCCH order triggers a PRACH transmission. This is illustrated in FIG. 15. In one example of FIG. 15, multiple PRACH preambles are transmitted in response to a PDCCH order. A PRACH preamble of the multiple PRACH preambles is associated with an UL spatial domain transmission filter. In one example, the PDCCH order triggers N preambles. As aforementioned, M is UL spatial domain transmission filters (e.g., M UL beams).

In one example, N=M, a PRACH preamble can be associated with an UL spatial domain transmission filter. Wherein, a UE can perform beam sweeping using the PRACH preambles, a PRACH preamble is associated with an UL spatial domain transmission filter.

In one example, N>M, a UE uses M of the N PRACH preambles, wherein a PRACH preamble is associated with an UL spatial domain filter.

In one example, N>M, a UE uses all N PRACH preambles, wherein an UL spatial domain transmission filter is associated with one or more PRACH preambles.

In one example, N<M, a UE can select M spatial domain transmission filters and can associate a selected spatial domain transmission filter with a PRACH preamble.

In one example, N can be configured or updated by an RRC signaling and/or MAC CE signaling and/or L1 control signaling, e.g., DCI signaling.

In one example, N can be indicated in the PDCCH order.

In one example, N can depend on a UE capability.

In one example, the PDCCH order indicates the PRACH occasions to use for the N PRACH preamble transmissions. In one example, this is based on a SS/PBCH index and/or a PRACH mask index in the PDCCH order. In another example, multiple, e.g., N SS/PBCH index and/or a PRACH mask index are included in the PDCCH order. In another example, the PRACH occasions are determined based on a SS/PBCH index and/or a PRACH mask index included in the PDCCH order and next N−1 SS/PBCH indexes.

In one example, a PDCCH order can indicate which of the N PRACH preamble to transmit. In one example, an N-bit field is included in the PDCCH order with a one-to-one mapping between the bits of the field and the PRACH preambles, if a bit is (option A: “1”) (or option B: “0”) the corresponding preamble is transmitted, if a bit is (option A: “0”) (or option B: “1”) the corresponding preamble is not transmitted. In one example, a field that indicates the number (n) of preambles to transmit is included in the PDCCH order, wherein (option A: the first n of the N preambles are transmitted) (or option B: the last n of the N preamble are transmitted). In one example, a field that indicates the number (m) of preambles to not transmit is included in the PDCCH order, wherein (option A: the first m of the N preambles are not transmitted) (or option B: the last m of the N preamble are not transmitted).

In one example, the PRACH occasions are determined based on the existing RACH-ConfigGeneric and/or RACH-ConfigDedicated.

In one example, the PRACH occasions are determined based on a new RACH-ConfigGeneric and/or RACH-ConfigDedicated for UL TRP.

In one example of FIG. 15, a random access response (RAR) is sent for each PRACH preamble. In one example, if a random access response is not received for a preamble, the UE ramps up the power by a step size delta and retransmits the corresponding preamble. In one example, if a random access response is not received for all N preambles, the UE ramps up the power by a step size delta and retransmits all N preambles. In one example, the step size delta can be configured and/or updated by RRC signaling and/or MAC CE signaling and/or L1 control signaling, e.g., DCI signaling (DCI signaling can include PDCCH order or can be separate from the PDCCH order).

In one example of FIG. 15, an RAR is sent for a PDCCH order for all PRACH preambles. In one example, if a random access response is not received, the UE ramps up the power by a step size delta and retransmits all N preambles. In one example, the step size delta can be configured and/or updated by RRC signaling and/or MAC CE signaling and/or L1 control signaling, e.g., DCI signaling.

In one example, the RAR response is transmitted using a DL/UL TRP or using a DL only TRP. In one example, the RAR response is transmitted in a Type-1 common search space (CSS) set. In one example, the quasi-co-location for the PDCCH DMRS and the PDSCH DMRS of the RAR response is based on the SSB (or the first SSB) included in the PDCCH order. In one example, the quasi-co-location for the PDCCH DMRS and the PDSCH DMRS of the RAR response is based on the DMRS of PDCCH order (e.g., the PDCCH DMRS and the PDSCH DMRS of the RAR have the same QCL source (or spatial relation source) as the DMRS of the PDCCH order).

In one example of FIG. 15, there is no RAR in response to PRACH preambles. In one example, if a UE sends a new PDCCH order, the UE can indicate whether to (1) ramp up the power of the PRACH transmission by a step size compared to the previous PRACH transmission power (2) use initial power for PRACH transmission. In one example, if a UE sends a new PDCCH order, the PDCCH order can include a counter that indicates the number of step sizes to increase the power by over the initial PRACH transmission power. Wherein the step size can be configured or updated to the UE by an RRC signaling and/or MAC CE signaling and/or L1 control signaling, e.g. DCI signaling.

In one example, the initial power of the PRACH preamble transmission is configured by the network.

In one example, a PLRS is configured for PRACH preamble transmission. The transmit power of the PRACH preamble is determined based on the pathloss measured using the PLRS. In a further example, an offset is configured or updated to the UE by RRC signaling and/or MAC CE signaling and/or L1 control signaling. The offset can adjust (added to or subtracted from) the pathloss measured using the PLRS or PRACH preamble transmission power determined based on the PLRS.

FIG. 16 illustrates an example of network architecture for RACH operation 1600 according to embodiments of the present disclosure. An embodiment of the network architecture for RACH operation 1600 shown in FIG. 16 is for illustration only.

In one example, M PLRS is configured for a PRACH preamble. The transmit power of the PRACH preamble is determined based on the pathloss measured using the M PLRS, e.g., as illustrated in FIG. 16 using one of the following examples.

The pathloss is determined based on the smallest pathloss measured using the M PLRS.

The pathloss is determined based on the largest pathloss measured using the M PLRS.

The pathloss is determined as the average (e.g., in linear domain or in dB domain) of the pathloss measured using the M PLRS.

A UE is further indicated a pathloss RS in the PDCCH order.

A UE is further indicated a pathloss RS to use by a dynamic signaling (e.g., by MAC CE signaling and/or L1 control signaling, e.g., DCI signaling (DCI signaling can include PDCCH order or can be separate from the PDCCH order)), or configured a pathloss RS by RRC signaling.

In another example, an offset is configured or updated to the UE by an RRC signaling and/or MAC CE signaling and/or L1 control signaling, e.g., DCI signaling (DCI signaling can include PDCCH order or can be separate from the PDCCH order). The offset can adjust (added to or subtracted from) the pathloss determined based on the above examples, or the transmission power determined based on the pathloss based on the above examples.

In one example, a UE maintains one DL reference (reception) time. The UE transmits the PRACH preamble(s) at a time determined by the DL reference (reception) time and NTA, Offset. In a further example, a UE can be configured an additional timing offset by an RRC signaling and/or MAC CE signaling and/or L1 control signaling, e.g., DCI signaling (DCI signaling can include PDCCH order or can be separate from the PDCCH order) that can be added to or subtracted from the determined time. In another example, a UE can be indicated in the PDDCH order an additional timing offset that can be added to or subtracted from the determined time.

In one example, a UE maintains K DL reference (reception) times, e.g., based on reception from K DL and/or DL/UL TRPs. The UE transmits the PRACH preamble(s) at a time determined by one of the K DL reference (reception) times and N_{TA,Offset}. The downlink reference time can be determined based on one of the following examples.

In one example, the DL reference (reception) time is determined based on the earliest of the K DL reference (reception) times.

In another example, the DL reference (reception) time is determined based on the latest of the K DL reference (reception) times.

In yet another example, the DL reference (reception) time is determined as the average of the K DL reference (reception) times.

In yet another example, a UE is further indicated a DL reference (reception) time in the PDCCH order.

In yet another example, a UE is further indicated a DL reference (reception) time to use by dynamic signaling (e.g., by MAC CE signaling and/or L1 control signaling).

In one example, a UE can be configured with an additional timing offset by an RRC signaling and/or MAC CE signaling and/or L1 control signaling, e.g., DCI signaling (DCI signaling can include PDCCH order or can be separate from the PDCCH order) that can be added to or subtracted from the determined time. In one example, a UE can be indicated in the PDDCH order an additional timing offset that can be added to or subtracted from the determined time.

In one example, a UE is signaled in a RAR or in a MAC CE or L1 control information separate from the RAR, one or more of the following examples.

In one example, a preferred PRACH preamble transmission or transmissions(s) out of the N PRACH preamble transmissions is provided. For example, this can be a preamble transmission with a receive power at the UL TRP exceeding a threshold, or that has the highest receive power or determined by network implementation.

In another example, a time advance command that can be used to determine the timing of UL transmission from the UE is provided.

In one example, a power control command to indicate the amount of power adjustment (add or subtract) that the UE can perform for uplink transmissions is provided.

In one example, a trigger for SRS transmission is provided, e.g., to activate a semi-persistent SRS resource or SRS resource set or a trigger aperiodic SRS resource or SRS resource set.

In one example, SRS can be configured after initial beam identification/pairing e.g., initial beam identification/pairing is performed by a PDCCH order as aforementioned, and in the process a UE can acquire TA and power for UL transmissions to the UL TRP. In one example, the SRS resource is configured without a TCI state (e.g., UL TCI state or DL/Joint TCI state) and without a spatial relation (e.g., spatialRelationInfo). In one example, the SRS resource set containing the SRS resource is configured with “usage” set to “beamManagement.” In one example, the SRS resource set containing the SRS resource is configured without having “followUnifiedTCI-StateSRS.” The UE determines a spatial domain transmission filter and/or transmission power and/or timing advance (TA) for the SRS resource based on the identified beam during initial beam identification/paring e.g., initial beam identification/pairing is performed by a PDCCH order or the corresponding RAR response.

In one example, SRS can be configured before initial beam identification e.g., an initial beam identification/pairing can be performed using SRS transmission.

In one example, the SRS resource is configured without a TCI state (e.g., UL TCI state or DL/Joint TCI state) and without a spatial relation (e.g., spatialRelationInfo). In one example, the SRS resource set containing the SRS resource is configured with “usage” set to “beamManagement.” In one example, the SRS resource set containing the SRS resource is configured without having “followUnifiedTCI-StateSRS.” The UE determines a spatial domain transmission filter for the SRS resource based on the UE's implementation, for example, to perform beam sweeping across the spatial domain transmissions filters.

In one example, the SRS resource is configured with a PCI.

In one example, the SRS resource set is configured with a PCI.

In one example, the SRS resource is configured with a pathloss reference signal (e.g., SSB or NZP CSI-RS (e.g., periodic or semi-persistent CSI-RS) and the pathloss reference signal (PLRS) includes or is associated with a PCI. In a further example, if there is no PCI included in or associated with the PLRS, the PLRS is for a serving cell.

In one example, the SRS resource set is configured with a pathloss reference signal (e.g., SSB or NZP CSI-RS (e.g., periodic or semi-persistent CSI-RS) and the pathloss reference signal (PLRS) includes or is associated with a PCI. In a further example, if there is no PCI included in or associated with the PLRS, the PLRS is for a serving cell.

In one example, SRS can be configured to be used for one or more of: (1) source RS for UL TCI states to UL TRP; (3) pathloss RS for UL transmissions to UL TRP; and/or (3) to maintain synchronization between and UL TRP, based on SRS transmissions, a network can determine a TA value and send a TA command to the UE.

In one example, a UE is configured with an SRS resource set or multiple SRS resource sets. The SRS resource set includes N SRS resources. In one example, the “usage” (or similar parameter) of the SRS resource set or SRS resource can be set to “beamManagement” or beam management for UL TRP or the like. As aforementioned, M is UL spatial domain transmission filters (e.g., M UL beams).

In one example, N=M, an SRS resource can be associated with an UL spatial domain transmission filter. Wherein, a UE can perform beam sweeping using the SRS resources, an SRS resource is associated with a spatial domain transmission filter.

In one example, N>M, a UE uses M of the N SRS resources, wherein an SRS resource is associated with an UL spatial domain filter.

In one example, N>M, a UE uses all N SRS resources, wherein an UL spatial domain transmission filter is associated with one or more SRS resources.

In one example, N<M, a UE can select M spatial domain transmission filters and can associate a selected spatial domain transmission filter with an SRS resource.

In one example, a SRS resource is association with a corresponding SRS preamble. For example, SRS resource #i is associated with PRACH preamble #i for i=0 to N−1, wherein SRS resource #i and PRACH preamble #i use a same spatial domain transmission filter.

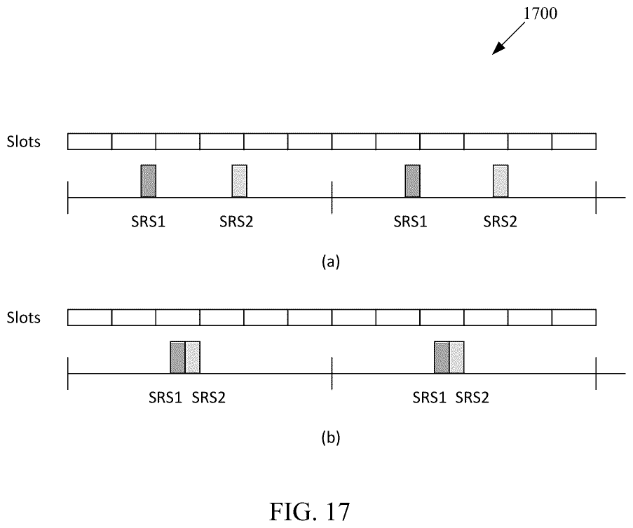

FIG. 17 illustrates an example of SRS resources 1700 according to embodiments of the present disclosure. An embodiment of the SRS resources 1700 shown in FIG. 17 is for illustration only.

In one example, the SRS resource set and/or SRS resource is configured as a periodic SRS resource set and/or periodic SRS resource. The SRS resources in the SRS resource set can have a same period. In one example, two SRS resources in the SRS resource set can have different slot offsets within the period as illustrated in FIG. 17 (e.g., (a) as illustrated in FIG. 17). In one example, two SRS resources in the SRS resource set can have a same slot offset, but a different symbol offsets with a slot as illustrated in FIG. 17 (e.g., (b) as illustrated in FIG. 17).

In one example, the SRS resource set and/or SRS resource is configured as a semi-persistent SRS resource set and/or semi-persistent SRS resource. The SRS resources in the SRS resource set can have a same period. In one example, two SRS resources in the SRS resource set can have different slot offsets within the period as illustrated in FIG. 17 (e.g., (a) of FIG. 17). In one example, two SRS resources in the SRS resource set can have a same slot offset, but a different symbol offsets with a slot as illustrated in FIG. 17 (e.g., (b) of FIG. 17)).

In one example, a UE can receive a first MAC CE command to activate the transmission of the semi-persistent SRS resource set. A UE can receive a second MAC CE to deactivate the transmission of the semi-persistent SRS resource set. In one example, the MAC CE activation or deactivation can be for all SRS resources in the SRS resource set. In one example, the MAC CE activation or deactivation can be for a subset of SRS resources in the SRS resource set. In one example, an N-bit field is included in the MAC CE with a one-to-one mapping between the bits of the field and the SRS resources, if a bit is (option A: “1”) (or option B: “0”) the corresponding SRS resource is transmitted, if a bit is (option A: “0”) (or option B: “1”) the corresponding SRS resource is not transmitted.

In one example, a field that indicates the number (n) of SRS resources to transmit is included in the MAC CE, wherein (option A: the first n of the N SRS resources are transmitted) (or option B: the last n of the N SRS resources are transmitted). In one example, a field that indicates the number (m) of SRS resources to not transmit is included in the MAC CE, wherein (option A: the first m of the N SRS resources are not transmitted) (or option B: the last m of the N SRS resources are not transmitted).

In one example, a UE can receive a first PDCCH (e.g., with a DCI Format) to activate the transmission of the semi-persistent SRS resource set. A UE can receive a second PDCCH (e.g., with a DCI Format) to deactivate the transmission of the semi-persistent SRS resource set. In one example, the DCI activation or deactivation can be for all SRS resources in the SRS resource set. In one example, the DCI activation or deactivation can be for a subset of SRS resources in the SRS resource set. In one example, an N-bit field is included in the DCI with a one-to-one mapping between the bits of the field and the SRS resources, if a bit is (option A: “1”) (or option B: “0”) the corresponding SRS resource is transmitted, if a bit is (option A: “0”) (or option B: “1”) the corresponding SRS resource is not transmitted.

In one example, a field that indicates the number (n) of SRS resources to transmit is included in the DCI, wherein (option A: the first n of the N SRS resources are transmitted) (or option B: the last n of the N SRS resources are transmitted). In one example, a field that indicates the number (m) of SRS resources to not transmit is included in the DCI, wherein (option A: the first m of the N SRS resources are not transmitted) (or option B: the last m of the N SRS resources are not transmitted).

In one example, the SRS resources or the SRS resource set have no spatial relation or source RS or TCI state.

In one example, the initial power of the SRS transmission is configured by the network.

In one example, the initial power of the SRS transmission can be determined based on the PRACH preamble transmission performed before SRS transmission. In one example, the network determines the SRS transmission power and configures the power to the UE using MAC CE and/or L1 control, e.g., DCI signaling and/or RRC signaling. In one example, a UE determines the SRS transmission power based on power control information the UE receives in response to a PRACH preamble transmission. In one example, a UE determines the SRS transmission power based on the last transmission power of the PRACH preamble using a same UL spatial domain transmission filter.

In one example, a PLRS is configured for an SRS resource set. The transmit power of an SRS resource in the SRS resource set is determined based on the pathloss measured using the PLRS. In a further example, an offset is configured or updated to the UE by RRC signaling and/or MAC CE signaling and/or L1 control signaling, e.g., DCI signaling. The offset can adjust (added to or subtracted from) the pathloss measured using the PLRS or SRS transmission power determined based on the PLRS.

In one example, M PLRS are configured for an SRS resource set. The transmit power of an SRS resource in the SRS resource set is determined based the pathloss measured using the M PLRS using one of the following examples.

In one example, the pathloss is determined based on the smallest pathloss measured using the M PLRS.

In another example, the pathloss is determined based on the largest pathloss measured using the M PLRS.

In yet another example, the pathloss is determined as the average (e.g., in linear domain or in dB domain) of the pathloss measured using the M PLRS.

In yet another example, a UE is further indicated or configured a pathloss RS to use by dynamic signaling (e.g., by MAC CE signaling and/or L1 control signaling, e.g., DCI signaling and/or RRC signaling).

In a further example, an offset is configured or updated to the UE by RRC signaling and/or MAC CE signaling and/or L1 control signaling, e.g., DCI signaling. The offset can adjust (added to or subtracted from) the pathloss determined based on the above examples, or the transmission power determined based on the pathloss based on the above examples.

In one example, a PLRS is configured for an SRS resource. The transmit power of the SRS resource is determined based on the pathloss measured using the PLRS. In a further example, an offset is configured or updated to the UE by RRC signaling and/or MAC CE signaling and/or L1 control signaling. The offset can adjust (added to or subtracted from) the pathloss measured using the PLRS or SRS transmission power determined based on the PLRS.

In one example, M PLRS are configured for an SRS resource. The transmit power of the SRS resource is determined based on the pathloss measured using the M PLRS, e.g., as illustrated in FIG. 17, using one of the following examples.

In one example, the pathloss is determined based on the smallest pathloss measured using the M PLRS.

In another example, the pathloss is determined based on the largest pathloss measured using the M PLRS.

In yet another example, the pathloss is determined as the average (e.g., in linear domain or in dB domain) of the pathloss measured using the M PLRS.

A UE is further indicated a pathloss RS to use by dynamic signaling (e.g., by MAC CE signaling and/or L1 control signaling), or configured a pathloss RS by RRC signaling.

In one example, an offset is configured or updated to the UE by an RRC signaling and/or MAC CE signaling and/or L1 control signaling, e.g., DCI signaling. The offset can adjust (added to or subtracted from) the pathloss determined based on the above examples, or the transmission power determined based on the pathloss based on the above examples.

In one example, the SRS transmission timing—TA—can be determined based on the PRACH preamble transmission performed before SRS transmission. In one example, a UE determines the SRS transmission time based on TA command the UE receives in response to a PRACH preamble transmission.

In one example, a UE maintains one DL reference (reception) time. The UE transmits the SRS resource at a time determined by the DL reference (reception) time and NTA, Offset. In a further example, a UE can be configured an additional timing offset by RRC signaling and/or MAC CE signaling and/or L1 control signaling, e.g., DCI signaling that can be added to or subtracted from the determined time.

In one example, a UE maintains K DL reference (reception) times, e.g., based on reception from K DL and/or DL/UL TRPs. The UE transmits the SRS resource at a time determined by one of the K DL reference (reception) times and NTA, Offset. The downlink reference time can be determined based on one of the following examples.

In one example, the DL reference (reception) time is determined based on the earliest of the K DL reference (reception) times.

In one example, the DL reference (reception) time is determined based on the latest of the K DL reference (reception) times.

In one example, the DL reference (reception) time is determined as the average of the K DL reference (reception) times.

In one example, a UE is further indicated with a DL reference (reception) time to use by dynamic signaling (e.g., by MAC CE signaling and/or L1 control signaling).

In one example, a UE can be configured with an additional timing offset by an RRC signaling and/or MAC CE signaling and/or L1 control signaling, e.g., DCI signaling that can be added to or subtracted from the determined time.

In one example, the SRS resource is used for UL power control. The network can adjust the transmission power of an SRS resource used as PLRS for an UL transmission. In one example, the power of PUSCH is calculated relative to the power of SRS, wherein Power of PUSCH=Power of SRS used as PLRS+Adjustment, wherein the Power of PUSCH does not exceed a maximum value (e.g., P_{CMAX,f,c} (i), see 3GPP specification TS 38.213), the adjustment can depend on one or more of the following examples.

In one example, an offset configured and/or updated by an RRC signaling and/or MAC CE signaling and/or L1 control signaling, e.g., DCI signaling is provided.

In one example, a bandwidth (e.g., in PRBs) of the PUSCH transmission is provided.

In another example, a bandwidth (e.g., in PRBs) of the SRS resource is provided.

In yet another example, a modulation coding scheme of the PUSCH transmission and number of layers, e.g., Δ_{TF,b,f,c} (i) are provided. (e.g., 3GPP specification TS 38.213). A closed loop power control component for PUSCH.

In one example, the power of PUCCH is calculated relative to the power of SRS, wherein Power of PUCCH=Power of SRS used as PLRS+Adjustment, wherein the Power of PUCCH does not exceed a maximum value (e.g., P_{CMAX,f,c} (i) see 3GPP specification TS 38.213, and the adjustment can depend on one or more of the following examples.

In one example, an offset configured and/or updated by an RRC signaling and/or MAC CE signaling and/or L1 control signaling, e.g., DCI signaling is provided.

In another example, bandwidth (e.g., in PRBs) of the PUCCH transmission is provided.

In yet another example, a bandwidth (e.g., in PRBs) of the SRS resource is provided.

In yet another example, a PUCCH format, e.g., based on Δ_{F_PUCCH}(F), see 3GPP specification TS 38.213.

A PUCCH transmission power adjustment component Δ_{TF,b,f,c} (i), see 3GPP specification TS 38.213.

A closed loop power control component for PUCCH is provided.

The present disclosure includes: (1) an initial beam acquisition for UL TRP; (2) using SRS as source RS and PLRS for UL TRP; (3) in this disclosure, methods and procedures for UL TRP operation including initial beam acquisition based on a PRACH preamble triggered by PDCCH order and/or using SRS resource are provided.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to receive a set of reference signals (RSs); and
a processor operably coupled to the transceiver, the processor configured to:
measure a first quantity based on a quality of a RS in the set of RSs,
determine a second quantity based on a rate of change of the first quantity, and
prepare a report including N≥1 entries, wherein each entry in the N entries includes:
a RS indicator of the RS,
the first quantity, and
the second quantity,
wherein the transceiver is further configured to transmit the report.

2. The UE of claim 1, wherein the first quantity is a reference signal received power (RSRP).

3. The UE of claim 1, wherein:
the second quantity is a flag that is indicative of the first quantity increasing or decreasing,
when the first quantity is increasing, the RS is preferred, and
when the first quantity is decreasing, the RS is not preferred.

4. The UE of claim 1, wherein the set of RS includes:
a synchronization signal/physical broadcast channel (SS/PBCH) block, or
a channel state information (CSI)-RS.

5. The UE of claim 1, wherein
the first quantity is a predicted measurement at a time T, and
the report includes the time T.

6. The UE of claim 1, wherein:
the transceiver is further configured to:
receive a list of offsets, and
receive downlink control information (DCI) indicating an offset from the list of offsets,
the processor is further configured to determine a power based on the offset, and
the transceiver is further configured to transmit a physical downlink control channel (PDCCH) order-triggered physical random access channel (PRACH) preamble with the power.

7. The UE of claim 1, wherein the transceiver is further configured to:
receive a physical downlink control channel (PDCCH) order, and
in response to reception of the PDCCH order, transmit N>1 physical random access channel (PRACH) preambles.

8. A base station (BS), comprising:
a processor; and
a transceiver operably coupled to the processor, the transceiver configured to:
transmit a set of reference signals (RSs), and
receive a report, wherein the report includes N≥1 entries and each entry in the N entries includes:
a RS indicator of a RS in the set of RSs,
a first quantity that is based on a quality of the RS, and
a second quantity that is based on a rate of change of the first quantity.

9. The BS of claim 8, wherein the first quantity is a reference signal received power (RSRP).

10. The BS of claim 8, wherein:
the second quantity is a flag that is indicative of the first quantity increasing or decreasing,
when the first quantity is increasing, the RS is preferred, and
when the first quantity is decreasing, the RS is not preferred.

11. The BS of claim 8, wherein the set of RS includes:
a synchronization signal/physical broadcast channel (SS/PBCH) block, or
a channel state information (CSI)-RS.

12. The BS of claim 8, wherein
the first quantity is a predicted measurement at a time T, and
the report includes the time T.

13. The BS of claim 8, wherein:
the transceiver is further configured to:
transmit a list of offsets,
transmit downlink control information (DCI) indicating an offset from the list of offsets, and
receive a physical downlink control channel (PDCCH) order-triggered physical random access channel (PRACH) preamble with a power, and
the power is based on the offset.

14. The BS of claim 8, wherein the transceiver is further configured to:
transmit a physical downlink control channel (PDCCH) order, and
receive N>1 physical random access channel (PRACH) preambles in response to the PDCCH order.

15. A method of operating a user equipment (UE), the method comprising:
receiving a set of reference signals (RSs);
measuring a first quantity based on a quality of a RS in the set of RSs;
determining a second quantity based on a rate of change of the first quantity;
preparing a report including N≥1 entries, wherein each entry in the N entries includes:
a RS indicator of the RS,
the first quantity, and
the second quantity; and
transmitting the report.

16. The method of claim 15, wherein:
the first quantity is a reference signal received power (RSRP), and
the set of RS includes:
a synchronization signal/physical broadcast channel (SS/PBCH) block, or
a channel state information (CSI)-RS.

17. The method of claim 15, wherein:
the second quantity is a flag that is indicative of the first quantity increasing or decreasing,
when the first quantity is increasing, the RS is preferred, and
when the first quantity is decreasing, the RS is not preferred.

18. The method of claim 15, wherein:
the first quantity is a predicted measurement at a time T, and
the report includes the time T.

19. The method of claim 15, further comprising:
receiving a list of offsets;
receiving downlink control information (DCI) indicating an offset from the list of offsets;
determining a power based on the offset; and
transmitting a physical downlink control channel (PDCCH) order-triggered physical random access channel (PRACH) preamble with the power.

20. The method of claim 15, further comprising:
receiving a physical downlink control channel (PDCCH) order; and
in response to receiving the PDCCH order, transmitting N>1 physical random access channel (PRACH) preambles.
